(19) United States
(12) Patent Application Publication
(10) Pub. No.: US 2007/0148528 A1
(43) Pub. Date: Jun. 28, 2007

(54) Fuel cell generating system

(75) Inventor: Katsunori Sakai, Yokohama-si (JP)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/644,875

(22) Filed: Dec. 26, 2006

(30) Foreign Application Priority Data
Dec. 27, 2005 (JP) 2005-375221

(51) Int. Cl. H01M 8/02; H01M 8/06; H01M 8/10

(52) U.S. Cl. 429/38; 429/19; 429/30; 429/13

(57) ABSTRACT

A fuel cell generating system can reduce or prevent the degradation and increase the durability of a fuel cell main body without increasing the volume of the fuel cell generating system includes a fuel cell main body comprises an electrolyte membrane, an anode electrode and a cathode electrode disposed on separate sides of the electrolyte membrane, a first separator having gas flow channels that supply a fuel gas containing hydrogen to the anode electrode and a second separator having oxidant gas flow channels to supply an oxidant gas containing oxygen to the cathode electrode. A gas supply system that supplies a non-reactive gas to the anode gas flow channel besides the oxidant gas and the fuel gas, wherein, during a starting operation, a predetermined amount of the non-reactive gas is supplied to the anode gas flow channel, and the fuel gas is supplied after the supply the non-reactive gas.

### CROSS-REFERENCE TO RELATED APPLICATION

This application claims the benefit of Japanese Patent Application No. 2005-375221, filed on Dec. 27, 2005 in the Japanese Intellectual Property Office, the disclosure of which is incorporated herein by reference.

### FIELD OF THE INVENTION

Aspects of the present invention relate to a fuel cell generating system that can reduce degradation and increase durability of a fuel cell that is operated in a daily start and stop operation system.

### DESCRIPTION OF THE RELATED ART

Generally, a fuel cell of a household is operated in a daily start and stop (DSS) operation system where the fuel cell operates during the day and stops at night to save fuel and to reduce CO₂ emission. Therefore, the fuel cell of a household may have an operating pattern that can flexibly select stop and start of the fuel cell.

A related art fuel cell generating system is designed to perform an operation to remove remaining gases in pipelines and in a main body of the fuel cell using an inert gas when an operation of the fuel cell is either started or stopped for the following reasons. The first reason is for safety, whereby when air enters into the pipelines or the main body of the fuel cell where a hydrogen gas remains, there is a possibility of generating a combustion or an explosion. The second reason is the degradation of the fuel cell, whereby when the fuel cell in a no-load state contains remaining hydrogen gas and air, a voltage difference close to an open circuit voltage is generated between a fuel electrode and an air electrode. At this point, the air electrode is in a higher voltage state than the fuel electrode. Therefore, the components of the air electrode of the fuel cell, including a catalyst or a gas diffusion layer, can become corroded.

Due to the above-mentioned reasons, an operation to remove the remaining hydrogen gas in the pipelines and in the main body of the fuel cell is performed using an inert gas in the related fuel cell generating system.

However, the method to remove the remaining hydrogen gas in the pipelines and in the main body of the fuel cell uses an inert gas from an additional high pressure gas container or an additional facility to store the inert gas. Thus, the overall related fuel cell generating system occupies a large volume. Also, the related art fuel cell generating system incurs additional costs to refill the facility to store the inert gas or to periodically replace the high pressure gas container. Furthermore, an expert or a maintenance crew must also be stationed or available to control the gases. Therefore, the removal of the remaining hydrogen gas in the fuel cell generating system using an inert gas is not suitable for a portable fuel cell such as a vehicle mounted fuel cell that has recently become popular for transportation, or a compact household fuel cell.

Therefore, extensive research is being conducted to develop a fuel cell that does not use purging by an inert gas. However, it has been reported that if the purging by an inert gas is not performed, the fuel cell is severely degraded.

In the fuel cell generating system in which the purging by an inert gas is not performed, although extant for only a short time during start operation or stop operation, an interface region of hydrogen gas and air is present on an anode electrode of the fuel cell and while an air region is generated for a short time on a cathode electrode of the fuel cell. The problem associated with this phenomenon will now be described with reference to FIG. 16.

After a stop operation of the related art fuel cell generating system and immediately after an external load is terminated, the supply of air to a cathode electrode of the fuel cell and fuel (hydrogen rich gas) to an anode electrode of the fuel cell is suspended. Thereafter, a temperature reducing operation is performed on the fuel cell main body. As illustrated in FIG. 16A, immediately after the stop operation of the related art fuel cell generating system, the fuel cell main body has a gas flow channel 121 on a cathode electrode side that is filled with remaining air and a gas flow channel 131 on an anode electrode side that is filled with remaining fuel (hydrogen rich gas). After a period of time, some of the remaining fuel (i.e., hydrogen gas) in the gas flow channel 131 and some of the remaining air in the gas flow channel 121 diffuse into an electrolyte 101 and produce water by directly reacting on the catalysts 104 and 105. The consumption of the hydrogen gas in the anode electrode 103 reduces the pressure of hydrogen gas in the gas flow channel 131 on the anode electrode side. The pressure is further reduced in the gas flow channel 131 on the anode electrode side since the temperature reduction operation of the fuel cell main body occurs immediately after the stoppage of the fuel cell to cause a further volume reduction of the remaining gas in the fuel cell main body. Since an outlet line of a fuel cell main body is generally opened to the outside atmosphere in an atmospheric type fuel cell generating system, when a pressure reduction phenomenon occurs in the gas flow channel 131 on the anode electrode side as described above, external air enters (seeps into) the fuel cell through an outlet 131b (refer to FIG. 16B) of the gas flow channel 131 on the anode electrode side. Thus, as depicted in FIG. 16B, a region of hydrogen gas and a region of air are formed on the anode electrode 103. A boundary line between the two regions formed on the anode electrode 103 slowly moves towards an inlet 131a from the outlet 131b of the gas flow channel 131 on the anode electrode side since the hydrogen gas in the gas flow channel 131 is continuously consumed to form water as time passes. After a period of time, as depicted in FIG. 16C, the entire gas flow channel 131 on the anode electrode side is filled with air.

Just prior to a start operation of the fuel cell generating system that has been stopped for a long time, as depicted in FIG. 16C, the gas flow channel 121 on the cathode electrode side and the gas flow channel 131 on the anode electrode side are both filled with air. After a temperature increasing operation of the fuel cell main body is performed and completed while the gas flow channels 121 and 131 are filled with air, but prior to starting the fuel cell, a fuel gas (hydrogen rich gas) is supplied to the gas flow channel 131 on the anode electrode side and air is supplied to the gas flow channel 121 on the cathode electrode side. When the fuel gas is supplied, even though only a short time passes after the fuel gas (hydrogen rich gas) is supplied to the gas flow channel 131 on the anode electrode side, as depicted in FIG. 16D, a region of hydrogen gas and a region of air are formed on the anode electrode 103, which lead to degradation of the fuel cell main body.

The degradation phenomenon in the fuel cell main body will now be described with reference to FIGS. 17 and 18. The degradation phenomenon occurs when the region of hydrogen gas and the region of air are present side-by-side on the anode electrode 103 while an air region is present on the cathode electrode 102.

When the hydrogen gas and air are thus present on the anode electrode 103, the following reactions (1) and (2) occur between a hydrogen region 133 (shown in FIG. 17) and an air region 132 (shown in FIG. 17).
Reaction at the hydrogen region 133: H₂→2H⁺+2e⁻ (1)
Reaction at the air region 132: O₂+4H⁺+4e⁻→2H₂O (2)

When the reactions (1) and (2) as illustrated above occur, an in-plane flow of protons (H⁺) in the electrolyte 101 and a through-plane flow of protons (H⁺) that cross the electrolyte 101 are generated. Simultaneously, as indicated by the arrows, in-plane flows of electrons (e⁻) in each of the cathode electrode 102 and the anode electrode 103 are also generated. In the anode electrode 103, electrons (e⁻) move from the hydrogen region 133 to the air region 132. In the cathode electrode 102, electrons (e⁻) move in an opposite direction to those in the anode electrode 103. Accordingly, a voltage of the anode electrode 103 slightly changes (equal to an ohm loss) due to the in-plane movement of the electrons (e⁻) from the hydrogen region 133 to the air region 132. The electrolyte 101 is a relatively weak in-plane proton conductor, but a voltage of the electrolyte 101 between the hydrogen region 133 and the air region 132 is reduced significantly in voltage due to the small flow of protons.

According to Japanese Patent Publication No. 2004-523064, the voltage reduction in the electrolyte between a hydrogen region 133 and an air region 132 is approximately equal to a fuel cell circuit voltage (that is, 0.9 to 1.0 V). Due to the voltage reduction in the electrolyte 101 between the hydrogen region 133 and the air region 132, a through-plane flow of protons occur from an air region 122 (refer to FIG. 17) of the cathode electrode side to the air region 132 of the anode electrode side. The flow direction of the proton is opposite to that of the direction of the flow of protons during normal operations.

The voltage states caused by the in-plane and the through-plane directions of the anode electrode 103, the cathode electrode 102, and the electrolyte 101 are illustrated in FIG. 18. As shown, it is assumed that the voltage of region 121b (shown in FIG. 17) of the cathode electrode 102 (the voltage difference between the cathode electrode 102 and the electrolyte 101) greatly increases according to the localized voltage reduction of the electrolyte 101. According to Japanese Patent Publication No. 2004-523064, the increase in the cathode voltage (the voltage difference between the cathode electrode 102 and the electrolyte 101) is approximately from 1.5 to 1.8 V. Due to the significant increase in the voltage of region 121 of the cathode electrode 102, a carbon support and a cathode catalyst in the catalyst layer 104 at the region 121b of the cathode electrode 102 rapidly become corroded, to thereby greatly reduce the fuel cell performance.

In order to reduce the above-mentioned problem, the fuel cell generating system disclosed in Japanese Patent Publication No. 2004-523064 has proposed a starting method to very quickly supply a large amount of anode fuel gas (hydrogen rich gas) into the gas flow channels of the anode electrode side where air infiltrates during a long shutdown period, and to reduce the time used to flush the two separated regions of hydrogen gas and air on the anode electrode (the time required for the anode fuel gas to reach from the inlet to the outlet of the gas flow channel) when a starting operation of the fuel cell generating system is performed.

However, the above method of starting a fuel cell generating system disclosed in Japanese Patent Publication No. 2004-523064 is effective when extent of time to flush the two separated regions of hydrogen gas and air on the anode electrode 103 is reduced to approximately 1.0 second or less to satisfy the lifetime performance criteria of the fuel cell if purging by an inert gas is not used.

Also, the Japanese Patent Publication No. 2004-523064 reports that to obtain a durable fuel cell generating system where frequent stop and start operations occur, an anode fuel gas (hydrogen rich gas) to the anode electrode must be supplied in amounts to generate the occurrence of the two separated regions of hydrogen gas and air for only 0.05 second or less.

To realize the above method, a large amount of anode fuel gas (hydrogen rich gas) must be supplied to the anode electrode when the fuel cell starts. Therefore, a fuel cell generating system having a fuel reforming process system adaptable as a household fuel cell generating system would have a processing capacity of fuel gas greater than a normal load processing capacity of fuel. For example, in order to control (or minimize) the time of the occurrence of the two separated regions of hydrogen gas and air to approximately 0.05 second or less, the processing capacity of the fuel reforming process system must be increased to approximately 10 times or more than a normal processing capacity of the fuel reforming process system (approximated by using a normal load of a fuel cell main body of 0.2 A/cm² and a fuel efficiency of 80%). In this case, in designing such a bulky fuel cell generating system, it is difficult to achieve a balance in the fuel cell generating system, and a commercially viable fuel cell generating system due to high costs and huge volume.

Accordingly, although the fuel cell generating system disclosed in Japanese Patent Publication No. 2004-523064 can control the time of the occurrence of the two separated regions of hydrogen gas and air during a starting operation of the fuel cell generating system with the above configuration, the above configuration cannot fully solve the problem because of the continued occurrence of the undesirable region of hydrogen gas and the region of air on the anode electrode once operation of the fuel cell generating system is stopped.

### SUMMARY OF THE INVENTION

Aspects of the present invention includes a fuel cell generating system that can reduce the generation of two separated regions of hydrogen gas and air on an anode electrode in starting and stopping operations, can reduce the degradation of a main body of the fuel cell, and can increase the durability of the fuel cell main body without increasing the volume of the fuel cell generating system.

According to an aspect of the present invention, a fuel cell generating system includes a fuel cell main body that comprises an electrolyte membrane, an anode electrode and a cathode electrode disposed on separate sides of the electrolyte membrane, a first separator having gas flow channels that supply a fuel gas containing hydrogen to the anode electrode and a second separator that supply an oxidant gas containing oxygen to the cathode electrode, wherein the fuel cell generating system further includes: a gas supply system that supplies a non-reactive gas besides the oxidant gas and the fuel gas to the gas flow channel of the anode electrode side, wherein, during a starting operation of the fuel cell generating system, a predetermined amount of the non-reactive gas is supplied to the gas flow channel of the anode electrode side by the gas supply system, and the fuel gas is supplied after the supplying of the non-reactive gas.

The amount of the non-reactive gas supplied to the gas flow channel of the anode electrode side gas supply system may be less than a volume of the gas flow channel of the anode electrode side, to separate the fuel gas that is supplied after the non-reactive gas from a remaining gas in the gas flow channel of the anode electrode side.

The fuel cell generating system may further include: a gas purifying unit that purifies a raw gas, a fuel reforming process unit that generates the fuel gas supplied to the fuel cell main body by reforming the raw gas that is purified in the gas purifying unit, and a steam supply system that supplies steam to the fuel reforming process unit, wherein the non-reactive gas supplied to the gas flow channel of the anode electrode side is the raw gas purified in the gas purifying unit.

The fuel cell generating system may further include a gas purifying unit that purifies a raw gas, a fuel reforming process unit that generates the fuel gas supplied to the fuel cell main body by reforming the raw gas that is purified in the gas purifying unit, and a steam supply system that supplies steam to the fuel reforming process unit, wherein the non-reactive gas supplied to the gas flow channel of the anode electrode side is the steam produced in the steam supply system.

The fuel cell generating system may further include a gas purifying unit that purifies a raw gas, a fuel reforming process unit that generates the fuel gas supplied to the fuel cell main body using the raw gas purified in the gas purifying unit, and a steam supply system that supplies steam to the fuel reforming process unit, wherein the non-reactive gas supplied to the gas flow channel of the anode electrode side is a combustion gas exhausted from the fuel reforming process unit.

The fuel cell generating system may further include a suction device connected to an inlet of the gas flow channel of the anode electrode side, wherein an outlet of the gas flow channel of the anode electrode side is connected to a burner in a combustion unit that is included in the fuel reforming process unit, and the suction device performs a suction operation when the supply of the fuel gas to the fuel cell main body is cut due to a stoppage of the fuel cell main body to exhaust the fuel gas remaining in the gas flow channel of the anode electrode side to the outside and to direct the combustion gas remaining in the combustion unit of the fuel reforming process unit through the burner into the gas flow channel of the anode electrode side.

According to another aspect of the present invention, a fuel cell generating system includes a fuel cell main body that includes an electrolyte membrane, an anode electrode and a cathode electrode disposed on separate sides of the electrolyte membrane, a first separator having gas flow channels that supply a fuel gas containing hydrogen to the anode electrode and a second separator having oxidant gas flow channels to supply an oxidant gas containing oxygen to the cathode electrode, wherein the fuel cell generating system further includes: a gas supply system that supplies a non-reactive gas besides the oxidant gas and the fuel gas to the gas flow channels of the anode electrode side, wherein, during a stopping operation of the fuel cell generating system, the non-reactive gas is supplied to the gas flow channel of the anode electrode side immediately after the supply of the fuel gas by the gas supply system.

In the fuel cell generating system, the amount of non-reactive gas supplied to the gas flow channel of the anode electrode side may be greater than a volume of the gas flow channel of the anode electrode side.

According to still another aspect of the present invention, a fuel cell generating system includes a fuel cell main body that includes an electrolyte membrane, an anode electrode and a cathode electrode disposed on separate sides of the electrolyte membrane, a first separator having gas flow channels that supply a fuel gas containing hydrogen to the anode electrode and a second separator having oxidant gas flow channels that supply an oxidant gas containing oxygen to the cathode electrode, wherein the fuel cell generating system further includes: an oxidant gas supply system that supplies an oxidant gas to the cathode electrode, wherein the oxidant gas supply system is connected to the gas flow channel of the anode electrode side, and, when the fuel cell generating system is stopped, the fuel gas remaining in the gas flow channel of the anode electrode side is removed by the supply of the oxidant gas into the gas flow channel of the anode electrode side from the oxidant gas supply system.

The fuel cell generating system may further include a gas flow computing controller that calculates a time required for external air to enter the gas flow channel of the anode electrode side after the supply of fuel gas to the fuel cell main body is cut using figures of a volume of the gas flow channel of the anode electrode side, a speed of diffusion of hydrogen and oxygen, and a volume reduction of the fuel gas in the gas flow channel of the anode electrode side due to a temperature reduction of the fuel cell main body, wherein the gas flow computing controller removes the fuel gas remaining in the gas flow channel of the anode electrode side until the calculated time has passed after the supply of the fuel gas to the fuel cell main body has been cut.

According to aspects of the present invention, an apparatus to supply one or more gases to a fuel cell, includes: a first gas supplier to supply a first gas to the fuel cell; and a second gas supplier to supply a second gas to the fuel cell, wherein a reaction of the first gas and the second gas generates electricity in the fuel cell, and at least one of the first gas supplier and the second gas supplier supplies a non-inert third gas to the fuel cell to be interposed between the first gas and infiltrated air in the fuel cell.

According to aspects of the present invention, a fuel cell comprising a first gas channel, a second gas channel, and an electrolyte disposed between the first and second gas channels, includes: an oxidant disposed in the first gas channel; a fuel gas disposed in the first gas channel; and a non-reactive gas interposed between the fuel gas and the oxidant in the first gas channel.

According aspects of the present invention, a method of disposing gases in a fuel cell comprising a first gas channel, a second gas channel, and an electrolyte disposed between the first and second gas channels, includes: disposing an oxidant in the first gas channel; disposing a fuel gas in the first gas channel; and interposing a non-reactive gas between the fuel gas and the oxidant in the first gas channel.

According to aspects of the present invention, a starting operation method of an apparatus comprising a fuel cell and a fuel reformer, includes: raising a temperature of the fuel reformer; supplying a first non-inert gas to the fuel cell; supplying a second non-inert gas to the fuel cell; and supplying a fuel to the fuel cell, wherein the first non-inert gas is interposed between the fuel and an oxidant.

According to aspects of the present invention, a stopping operation method of an apparatus comprising a fuel cell and a fuel reformer, includes: stopping supply of air to the fuel reformer; stopping supply of a first non-inert gas to the fuel cell but continuing supply of a second non-inert gas to the fuel cell; and stopping supply of a fuel gas to the fuel cell, wherein the first non-inert gas is interposed between the fuel and an oxidant.

According to aspects of the present invention, a fuel cell includes: a cathode; an anode; and a gas channel of the anode, wherein a non-reactive gas is interposed between a fuel gas and an oxidant in the gas channel to reduce corrosion of the cathode.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a schematic drawing of a fuel cell generating system according to aspects of the present invention;

FIG. 2 is a cross-sectional view illustrating a fuel cell main body of the fuel cell generating system according to aspects of the present invention;

FIG. 3 illustrates a cross-sectional view of a gas state in a fuel cell main body of a fuel cell generating system according to aspects of the present invention;

FIG. 4 illustrates a schematic drawing of a fuel cell generating system according an aspect of the present invention;

FIG. 5 illustrates a schematic drawing of a fuel cell generating system according to an aspect of the present invention;

FIG. 6 illustrates a flow chart of a start operation method of the fuel cell generating system of FIG. 1, according to an aspect of the present invention;

FIG. 7 illustrates a flow chart of a start operation method of the fuel cell generating system of FIG. 1, according to an aspect of the present invention;

FIG. 8 illustrates a flow chart of a start operation method of the fuel cell generating system of FIG. 5, according an aspect of the present invention;

FIG. 9 illustrates a schematic drawing of a fuel cell generating system according to aspects of the present invention;

FIG. 10 illustrates a schematic drawing of a fuel cell generating system according an aspect of the present invention;

FIG. 11 illustrates a flow chart of a stop operation method of the fuel cell generating system of FIG. 1, according to an aspect of the present invention;

FIG. 12 illustrates a flow chart of a stop operation method of the fuel cell generating system of FIG. 1, according to an aspect of the present invention;

FIG. 13 illustrates a flow chart of a stop operation method of the fuel cell generating system of FIG. 5 according to an aspect of the present invention;

FIG. 14 illustrates a flow chart of a stop operation method of the fuel cell generating system of FIG. 9, according to an aspect of the present invention;

FIG. 15 illustrates a flow chart of a stop operation method of the fuel cell generating system of FIG. 9, according an aspect of the present invention;

FIG. 16 illustrates a cross-sectional view of a gas state in a fuel cell main body of a related art fuel cell generating system;

FIG. 17 illustrates a cross-sectional view of a gas state in a fuel cell main body of a related art fuel cell generating system; and

FIG. 18 is a graph illustrating voltages at different locations of the fuel cell main body of FIG. 17 of a related art fuel cell generating system.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

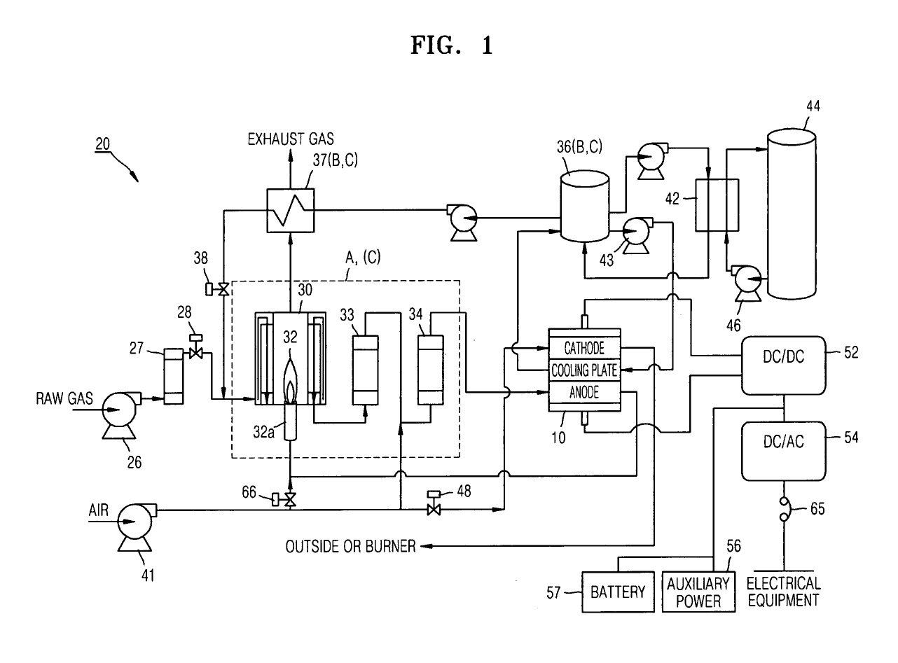

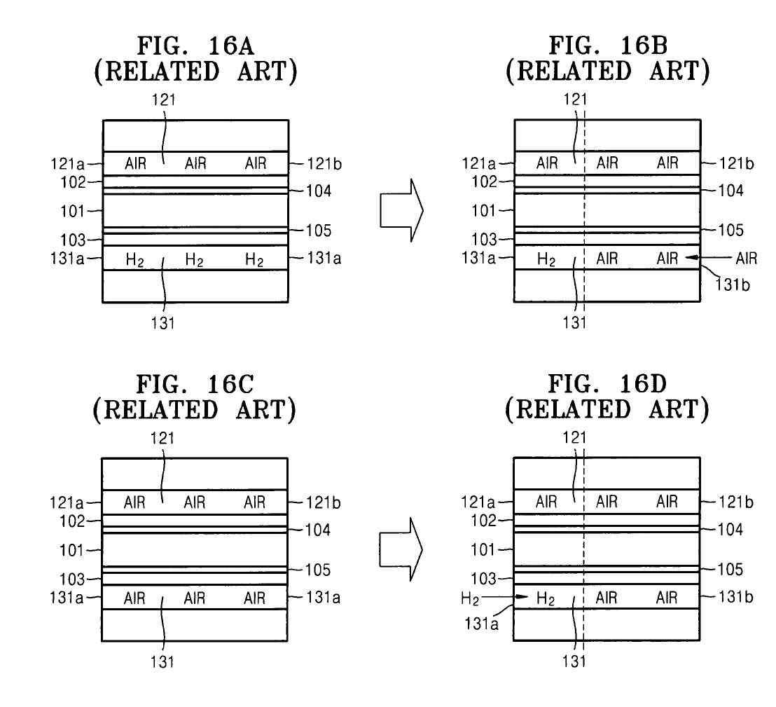

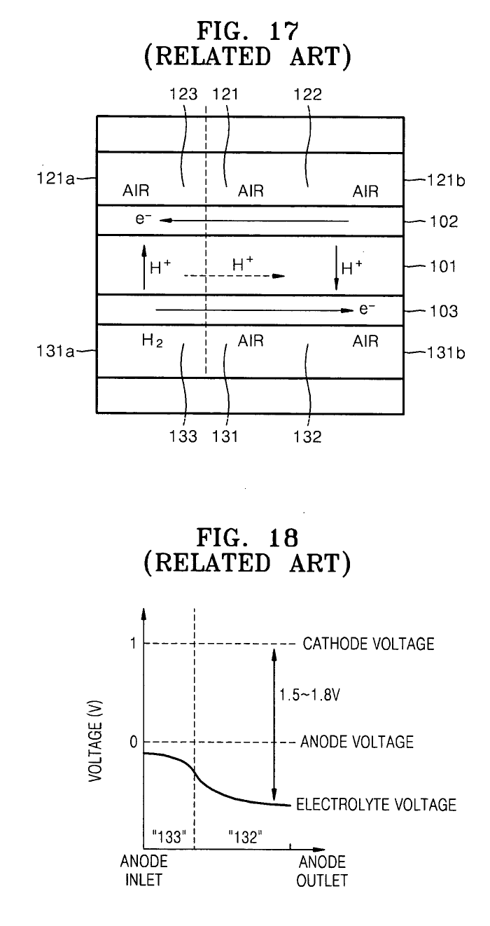

Fuel cell generating systems according to aspects of the present invention will now be described with reference to FIGS. 1 through 16.

### Embodiment 1

<A Fuel Cell Generating System>

FIG. 1 illustrates a schematic drawing of a fuel cell generating system 20 according to aspects of the present invention. As shown, the fuel cell generating system 20 includes a reformer 30 that reforms a raw fuel gas into a hydrogen rich gas by externally receiving the raw fuel gas, a fuel reforming process system (A) that includes a shift reactor 33 that generates a fuel gas by reducing CO content of the hydrogen rich gas from the reformer 30 and a CO selective oxidation unit 34, a fuel cell main body 10 that generates electricity through an electrochemical reaction between fuel gas and air, a heat exchanger 42 that performs heat exchange between cooling water of the fuel cell main body 10 and low temperature water in a warm water storage 44, a DC/DC converter 52 that converts a direct current (DC) from the fuel cell main body 10 into a desired direct current, and an inverter 54 that supplies power to a commercial power line (system) by transforming the voltage of a direct current received from the DC/DC converter 52 into an alternating current (AC) having the same voltage as the commercial power line (system).

The reformer 30 produces the hydrogen rich gas (fuel gas). The hydrogen rich gas is generated by a reaction between a fuel gas supplied from a fuel gas line through a booster pump 26, a desulfurizer 27 (gas purifying unit), and a control valve 28, and steam supplied from a steam supply system B that includes a purified water tank 36 and a vaporizer 37 through a control valve 38 that controls the flow rate of the steam. The hydrogen rich gas is produced through a steam reforming reaction in the reformer 30 and a shift reaction in a shift reactor 33 as indicated by the reactions (3) and (4) below.
CH₄+H₂O→CO+3H₂ (3)
CO+H₂O→CO₂+H₂ (4)

The reformer 30 includes a combustion chamber 32 to supply heat used for the above steam reforming reaction, and the combustion chamber 32 of the reformer 30 may be designed to receive unreacted hydrogen exhausted from the anode electrode 3 of the fuel cell main body 10.

The CO selective oxidation unit 34 receives air through pipelines (not shown), and produces a hydrogen rich gas having a very low CO content (for example, a few ppm) by oxidizing CO in the reformed gas (from the reformer 30) using a CO selective oxidation catalyst (for example, a CO selective oxidation catalyst formed of an alloy of Pt and Ru) that selectively oxidizes CO in the presence of hydrogen.

In the fuel cell generating system 20, each component that supply the various gases described above to the fuel cell main body 10 (such as the fuel reforming process system A and the steam supply system B) can function as a gas supply system C. For example, when a raw gas is used as a non-reactive gas and supplied to the fuel cell main body 10, the fuel reforming process system A can function as the gas supply system by a method which will be described later. Similarly, when steam is used as the non-reactive gas, the steam supply system B can function as the gas supply system by a method which also will be described later.

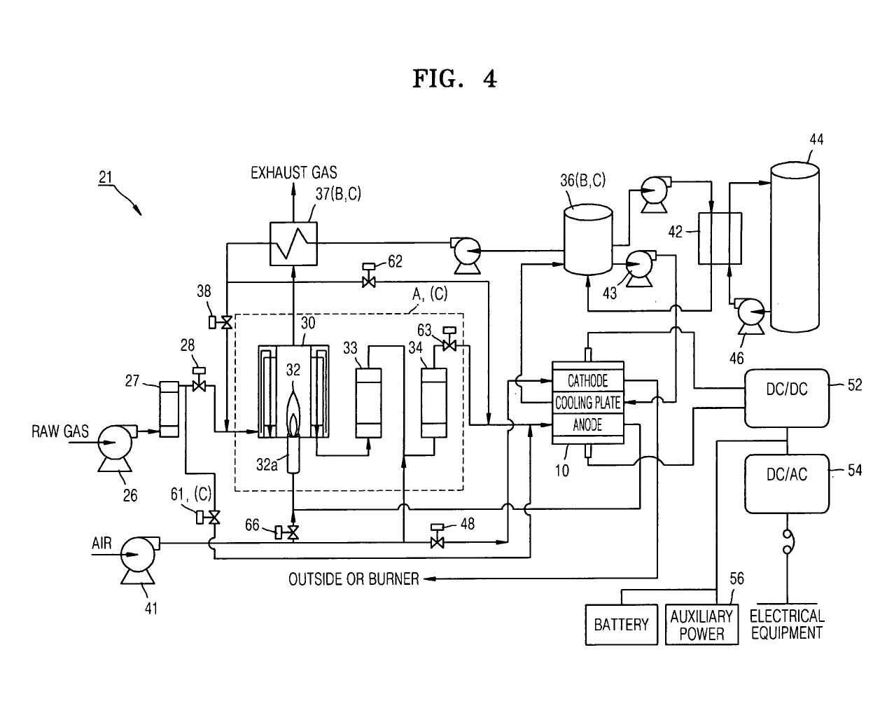

The gas supply system C is not limited to the fuel reforming process system A or the steam supply system B. That is, various other systems can be appropriately selected as the gas supply system C, for example, as depicted in FIG. 4, where the gas supply system C can be arranged by connecting a pipeline between an outlet of the desulfurizer 27 and the fuel cell main body 10.

The non-reactive gas used in the fuel cell generating system 20 according to aspects of the present invention is a non-reactive gas that does not include oxygen and hydrogen. Examples of such non-reactive gases include a raw gas, steam, air, an exhaust gas from combustion of the raw gas with air or fuel gas with air, or any combination thereof. Accordingly, non-reactive gas can be selected from gases that do not include oxygen.

<Fuel Cell Main Body>

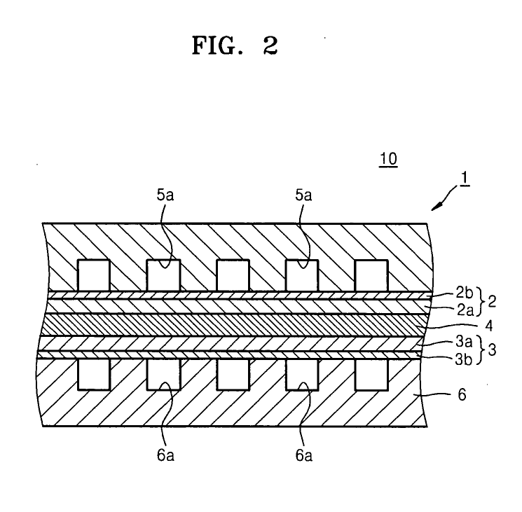

FIG. 2 is a cross-sectional view illustrating the fuel cell main body 10 of the fuel cell generating system 20 according to an aspect of the present invention. As shown, the fuel cell main body 10 is formed by stacking unit cells 1 shown in FIG. 2. In a non-limiting example, the fuel cell main body 10 is of a solid polymer type fuel cell. The unit cells 1 include a cathode electrode 2 (also referred to as a cathode), the anode electrode 3 (also referred to as an anode), an electrolyte membrane 4 (also referred to as an electrolyte) supported between the cathode electrode 2 and the anode electrode 3, an oxidant flow channel plate (or separator) 5 that includes oxidant gas flow channels 5a that are disposed outside of the cathode electrode 2, and a fuel flow channel plate (or separator) 6 that includes fuel gas flow channels 6a that are disposed outside the anode electrode 3.

The anode electrode 3 and the cathode electrode 2 respectively include porous catalyst layers 2a and 3a, and porous carbon sheets 2b and 3b that maintain the catalyst layers 2a and 3a. Each of the porous catalyst layers 2a and 3a includes an electrode catalyst, a hydrophobic binding agent to solidify the electrode catalyst, and a conductive material. The electrode catalyst can be a metal that can accelerate the oxidation reaction of hydrogen and the reduction reaction of oxygen, and may include Pb, Fe, Mn, Co, Cr, Ga, V, W, Ru, Ir, Pd, Pt, Rh, an alloy of these metals, or any combination thereof. Also, the electrode catalyst can be formed by soaking the metal or an alloy of these metals in activated carbon.

In a non-limiting example, the hydrophobic binding agent may be a fluorine resin having a melting point of 400° C. or less, a high hydrophobic property, and high thermal resistance. The fluorine resin can be polytetrafluoroethylene, a copolymer of tetrafluoroethylene-perfluoroalkylvinylether, polyvinylidene fluoride, a copolymer of tetrafluoroethylene-hexafluoroethylene, perfluoroethylene, or any combination thereof. The hydrophobic binding agent can reduce or prevent the porous catalyst layers 2a and 3a from becoming excessively wet by water produced during the power generation reaction, and can reduce or prevent the hindrance of the diffusion of fuel gas and oxygen in the anode electrode 3 and cathode electrode 2.

The conductive material can be any material that has an electrical conductivity such as metals or carbon materials. Non-limiting examples of the conductive material include one or a mixture of carbon black such as acetylene black, activated carbon, graphite, or any combination thereof.

The porous catalyst layers 2a and 3a may include an electrolyte material or an electrolyte material with the hydrophobic binding agent instead of only the hydrophobic binding agent. By use of the electrolyte material, proton conductivity in the anode electrode 3 and the cathode electrode 2 can be increased and the internal resistance of the anode electrode 3 and the cathode electrode 2 can be reduced.

The separators 5 and 6 can be formed of a conductive material, such as metal and are respectively connected to the cathode electrode 2 and the anode electrode 3. The separators 5 and 6 function as current collectors and supply oxygen and fuel gas respectively to the cathode electrode 2 and the anode electrode 3. That is, the fuel gas that contains hydrogen as a main component is supplied to the anode electrode 3 through gas channels 6a of the separator 6 on the anode electrode side, and oxygen as an oxidant is supplied to the cathode electrode 2 through the oxidant gas flow channels 5a of the separator 5 on the cathode electrode side. The hydrogen supplied as a fuel can be hydrogen produced by reforming hydrocarbon and/or alcohol, and the oxygen supplied as an oxidant can be oxygen included in the air, pure oxygen, and/or a gas with any concentration of oxygen.

In the unit cell 1 as described above, protons (H⁺) are produced at the anode electrode 3 due to the oxidation of hydrogen. The protons (H⁺) that are produced at the anode electrode 3 reach the cathode electrode 2 by being transmitted through the electrolyte membrane 4. At the cathode 2, electrical energy is generated through an electrochemical reaction between the protons and oxygen in producing water.

In an aspect of the present invention, the fuel cell main body 10 generates electricity through an electrochemical reaction between hydrogen in the fuel gas supplied from the CO selective oxidation unit 34 and oxygen in the air supplied from an air blower (an oxidant supply system) 41. The fuel cell main body 10 includes flow channels to circulate cooling water supplied by a booster pump 43 from the purified water tank 36. The fuel cell main body 10 is maintained at a temperature, for example, 80 to 90° C., by the circulation of the cooling water supplied by the booster pump 43 from the purified water tank 36. The heat exchanger 42 is installed on the circulating flow line of the cooling water from the purified water tank 36. Low temperature water supplied from a warm water tank 44 by a pump 46 exchanges heat with the cooling water from the fuel cell main body 10 so that the heated water is maintained warm in the warm water tank 44.

An output terminal of the fuel cell main body 10 may be connected to various electrical equipment through the DC/DC converter 52 and the DC/AC converter 54. DC electricity generated by the fuel cell main body 10 is transformed into AC electricity having the same voltage, and the alternating current (AC) electricity is supplied to the various electrical equipment.

Also, a power line is divided from the output of the DC/DC converter 52 and is connected to an auxiliary power 56 that consumes surplus electricity generated in the fuel cell generating system 20 and to a battery 57 that acts as a direct current source to supply power to components such as actuators of the control valves 28 and 38, the booster pumps 26 and 43, the air blower 41, and the pump 46, for example, when a stop operation of the fuel cell generating system 20 is performed.

<Method of the Starting Operation>

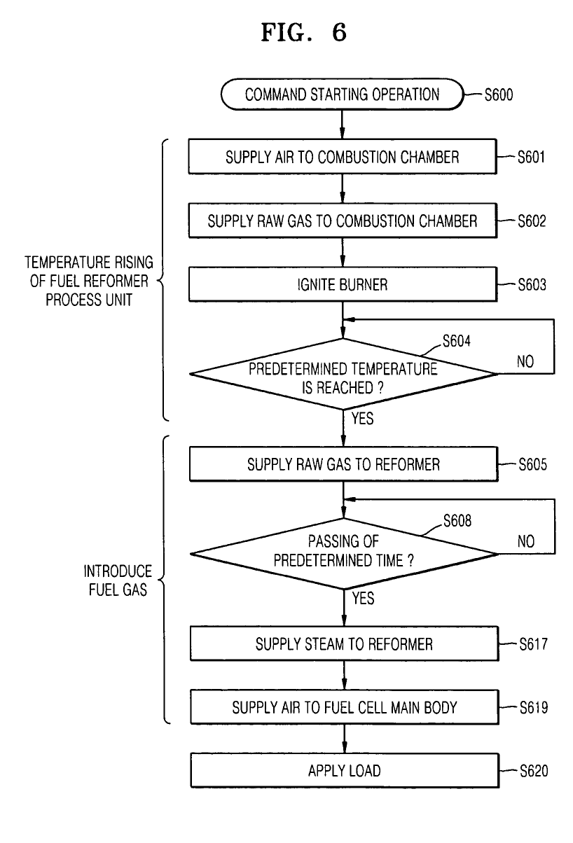

A starting operation method of the fuel cell generating system 20 having the above configuration will be described with reference to FIGS. 1, 2, and 6. Accordingly, FIG. 6 illustrates a flow chart of a starting operation method of the fuel cell generating system 20 of FIG. 1.

When the starting operation of the fuel cell generating system 20 is performed (operation S600), the air blower 41 supplies air to the combustion chamber 32 of the reformer 30 (operation S601). Then, the booster pump 26 of the raw gas line supplies a raw gas that has passed through the desulfurizer 27 to the combustion chamber 32 of the reformer 30 (operation S602). Then, the supplied fuel gas is burnt by igniting a burner 32a located below the combustion chamber 32 of the reformer 30 (operation S603), and the temperatures of the reformer 30 and the shift reactor 33 and the CO selective oxidation unit 34 adjacent to the reformer 30 increase. Although not shown, the temperature of water in the purified water tank 36 also increases by using the heat from the combustion chamber 32 of the reformer 30. Therefore, the temperature of the fuel cell main body 10 also increases.

Then, when the temperatures of each of the elements reach predetermined temperatures due to the temperature increasing process of the reformer 30, the shift reactor 33, the CO selective oxidation unit 34, and the fuel cell main body 10 (operation S604), a raw gas introduction operation is performed. At this point, the raw gas is supplied to the reformer 30 by opening the control valve 28 located in the downstream of the desulfurizer 27 (operation S605). Here, the raw gas passes through the reformer 30 and the CO selective oxidation unit 34 without undergoing a reforming reaction in the reformer 30. The raw gas is supplied to the gas flow channels 6a of the anode electrode side of the fuel cell main body 10 as a non-reactive gas to expel (displace or purge) air that has come to fill the gas flow channels 6a of the anode electrode side during a shutdown of the fuel cell main body 10 from the outside.

After an amount of raw gas (that is less than the volume of the gas flow channel 6a of the anode electrode side and that can separate from the air that entered from the outside from the raw gas) is supplied to the gas flow channel 6a of the anode electrode side or after a predetermined time passes (operation S608), steam is supplied to the reformer 30 (operation S617) by opening the control valve 38.

As a non-reactive gas, the amount of raw gas supplied to the gas flow channel 6a of the anode electrode side may be approximately 80 to 100% of the total volume of the gas flow channel 6a of the anode electrode side. If the amount of raw gas that is supplied to the gas flow channel 6a of the anode electrode side is less than 80% of the total volume of the gas flow channel 6a of the anode electrode side, there is a risk of increasing a voltage at a local portion (on an outlet side of the gas flow channel 6a of the anode electrode side) of the cathode electrode 2 to 1.2 V, even when the process takes (or is extant for) only a short time.

On the other hand, if the amount of raw gas supplied to the gas flow channel 6a of the anode electrode side exceeds 100% of the total volume of the gas flow channel 6a of the anode electrode side, the amount of raw gas is greater than an amount of raw gas useable to separate the air that entered from the outside from the fuel gas. Accordingly, this process is uneconomical by wasting raw gas.

By the starting operation method according to the aspect of FIG. 6, the steam reforming reaction indicated in equation (3), the shift reaction as indicated in equation (4), and a selective oxidation reaction respectively occur in the reformer 30, the shift reactor 33, and the CO selective oxidation unit 34. Therefore, a hydrogen rich fuel gas is supplied to the anode electrode 3 of the fuel cell main body 10. Afterwards, when air is supplied to the cathode electrode 2 of the fuel cell main body 10 by opening the control valve 48, the fuel cell main body 10 is ready to generate electricity. Accordingly, power can be supplied to electrical equipment.

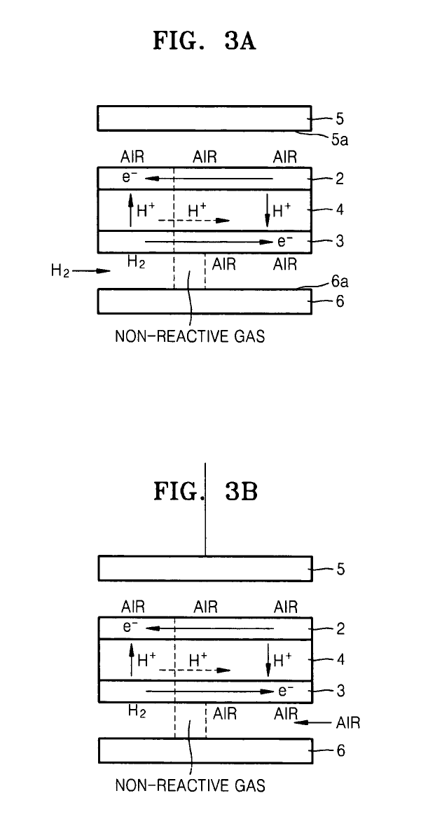

When the fuel cell main body 10 is ready to generate electricity, as depicted in FIG. 3A, the gas flow channel 6a of the anode electrode side contains a non-reactive raw gas region (layer or band) that does not contain oxygen and/or hydrogen. The non-reactive raw gas region is interposed between the fuel gas and the air that entered from the outside during shutdown. Thus, separated regions of hydrogen respectively contained in the fuel gas and oxygen do not occur side-by-side. Therefore, significant voltage increase in the cathode electrode 2 can be reduced or prevented, the corrosion of the catalyst layer 2a of the cathode electrode 2 can be reduced or prevented, and the durability of the fuel cell main body 10 can be significantly increased.

In this aspect, the amount of raw gas supplied as a non-reactive gas may be as low as possible as long as it is sufficient to generate a blocked state (or an interposing layer or band of raw gas) between the air and the fuel gas in the gas flow channel 6a of the anode electrode side.

As described above, during the starting operation of the fuel cell generating system 20 according to aspects of the present invention, a raw gas that does not participate in an electrochemical reaction can be interposed between air that entered (seeped) into the gas flow channel 6a of the anode electrode side and a fuel gas that is supplied from a fuel reforming process system (A) by supplying the raw gas to the reformer 30 at a predetermined time before the steam is supplied to the reformer 30. In this way, the occurrence of the two separated regions (formation of an interface or an adjacent region) of hydrogen and oxygen on the anode electrode 3 of the fuel cell main body 10 can be reduced or prevented.

In this aspect, the starting operation of the fuel cell generating system 20 where raw gas is supplied to the anode electrode 3 of the fuel cell main body 10 prior to supplying the hydrogen rich fuel gas using the pipeline configuration of a gas supplying system of FIG. 1 has been described. However, the same result can be obtained with a gas supply system as depicted in FIG. 4, in which a pipeline is connected from an outlet of the desulfurizer 27 to an inlet of the gas flow channel 6a of the anode electrode side of the fuel cell main body 10 through a shut-off valve 61.

In the aspect of the present embodiment using the system of FIG. 4, the temperature rising process of the starting operation includes the fuel gas introduction operation that is performed after temperatures of the reformer 30, the shift reactor 33, and the CO selective oxidation unit 34 respectively have reached predetermined temperatures, the raw gas supply operation that supplies raw gas to the gas flow channel 6a of the anode electrode side of the fuel cell main body 10 by opening the shut-off valve 61. Thereafter, the air that entered into the gas flow channel 6a of the anode electrode side during a shutdown of the fuel cell generating system 21 is expelled (displaced or purged) to the outside by the supplied raw gas.

After an amount of raw gas (that is less than an amount that can fill the gas flow channel 6a of the anode electrode side of the fuel cell main body 10 and that can separate the air that entered from the outside from the fuel gas) is supplied to the gas flow channel 6a of the anode electrode side of the fuel cell main body 10, the raw gas and steam are supplied to a reformer 30 by opening a control valve 28 and a control valve 38.

As a result, the steam reforming reaction indicated in equation (3), the shift reaction as indicated in equation (4), and the selective oxidation reaction are respectively generated in the reformer 30, a shift reactor 33, and a CO selective oxidation unit 34. Therefore, a hydrogen rich fuel gas is supplied to the anode electrode 3 of the fuel cell main body 10.

In this aspect of a gas supplying system of FIG. 4, as is the case with the pipeline configuration of FIG. 1, the generation of the two separated regions of hydrogen and oxygen on the anode electrode 3 of the fuel cell main body 10 can be reduced or prevented (as shown in FIG. 3A).

### Embodiment 2

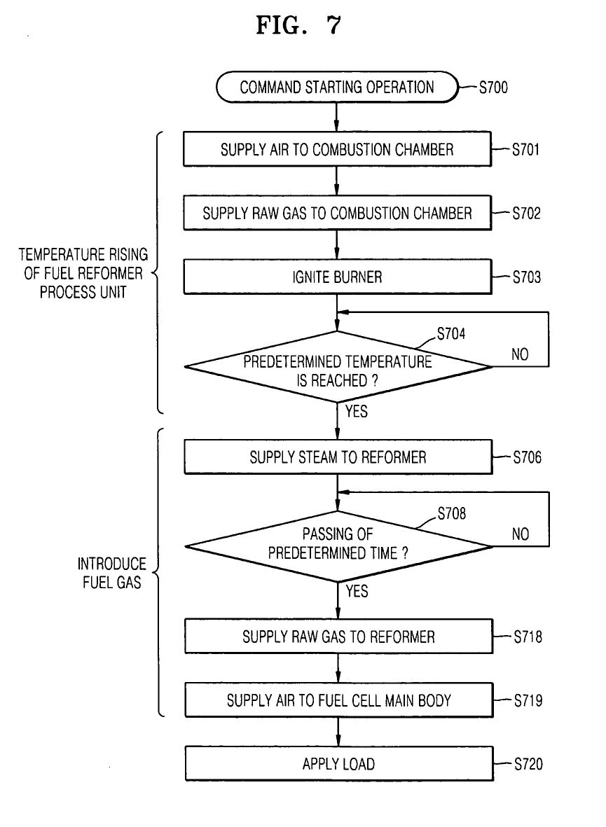

FIG. 7 illustrates a flow chart of a starting operation of the fuel cell generating system 20 of FIG. 1, according to an aspect of the present invention.

Because the functionality of the fuel cell generating system 20 and the configuration of the fuel cell main body 10 are basically identical, the detailed description thereof will be omitted. However, the starting operation is different as follows.

<Method of Starting Operation>

In this aspect of the present invention, the starting operation of the fuel cell generating system 20 and the temperature rising process of the reformer 30, the shift reactor 33, and the CO selective oxidation unit 34 (operations S700-S704) are identical to those of the aspect of FIG. 6 (operations S600-S604).

Accordingly, after the temperatures of each of the reformer 30, the shift reactor 33, and the CO selective oxidation unit 34 have reached predetermined temperatures (operations S700-S704), a fuel introduction operation is performed. First, steam is supplied to the reformer 30 by opening a control valve 38 (operation S706). In this aspect, the steam passes through the reformer 30 and the CO selective oxidation unit 34 without undergoing a reforming reaction in the reformer 30, is supplied to the gas flow channel 6a of the anode electrode side of the fuel cell main body 10, and expels (displaces) air that entered into the gas flow channel 6a of the anode electrode side of the fuel cell main body 10 during a shutdown of the fuel cell generating system 20 to the outside.

After the amount of steam (that is less than the volume of the gas flow channel 6a of the anode electrode side and that that can separate the air that entered from the outside from a fuel gas) is supplied to the gas flow channel 6a of the anode electrode side (and/or after a predetermined time passes) (operation S708), the control valve 28 is opened to supply a raw gas to the reformer 30 (operation S718).

As a non-reactive gas, the amount of steam supplied to the gas flow channel 6a of the anode electrode side may be approximately 80 to 100% of the total volume of the gas flow channel 6a of the anode electrode side.

If the amount of steam supplied to the gas flow channel 6a of the anode electrode side is less than 80% of the total volume of the gas flow channel 6a of the anode electrode side, the voltage of the cathode electrode 2 at an outlet side of the gas flow channel 6a of the anode electrode side can be increased to 1.2 V, even though the process takes (or is extant) for a short time.

On the other hand, the amount of steam supplied to the gas flow channel 6a of the anode electrode side exceeds 100% of the total volume of the gas flow channel 6a of the anode electrode side, the amount of steam is greater than an amount of steam usable to separate the air that entered from the outside from the fuel gas. Accordingly, the process is uneconomical by wasting steam.

By the starting operation method according to the aspect of FIG. 7, the steam reforming reaction indicated in equation (3), the shift reaction as indicated in equation (4), and the selective oxidation reaction respectively occur in the reformer 30, the shift reactor 33, and the CO selective oxidation unit 34. Therefore, a hydrogen rich fuel gas is supplied to the anode electrode 3 of the fuel cell main body 10. Afterwards, when air is supplied to the cathode electrode 2 of the fuel cell main body 10 by opening the control valve 48, the fuel cell main body 10 is ready to generate electricity. Accordingly, power can be supplied to electrical equipment.

As described above, during the starting operation of the fuel cell generating system 20 according to aspects of the present invention, steam that does not participate in an electrochemical reaction can be interposed between air that entered into the gas flow channel 6a of the anode electrode side and a hydrogen rich fuel gas that is supplied from a fuel reforming process system (A) by supplying the steam to the reformer 30 at a predetermined time before the raw gas is supplied to the reformer 30 (refer to FIG. 3A). In this way, the occurrence of the two separated regions (formation of an interface or adjacent regions) of hydrogen and oxygen on the anode electrode 3 of the fuel cell main body 10 can be reduced or prevented.

In the fuel cell generating system 20 according to this aspect of the present invention, since steam is only supplied to the anode electrode 3 of the fuel cell main body 10 for a predetermined time, the fuel cell generating system 20 is suitable for a fuel cell generating system in which the fuel cell main body 10 is operated at a temperature of over 100° C.

In this aspect of the starting operation of FIG. 7, the fuel cell generating system 20 supplies steam to the anode electrode 3 prior to supplying the hydrogen rich fuel gas using the pipeline configuration of FIG. 1. However, the same results can be obtained if a gas supply system C is used, as depicted in FIG. 4, in which a pipeline is connected from an outlet of the vaporizer 37 to an inlet of a gas flow channel 6a of an anode electrode side of a fuel cell main body 10 through a shut-off valve 61. Accordingly, FIG. 4 illustrates a schematic drawing of a configuration of a fuel cell generating system 21 according to another aspect of the present invention.

In the aspects of the present invention according to FIGS. 4 and 7, the temperature rising process of the starting operation includes the fuel gas introduction operation that is performed after temperatures of the reformer 30, the shift reactor 33, and the CO selective oxidation unit 34 respectively have reached predetermined temperatures (operations S700-S704), the steam is supplied to the gas flow channel 6a of the anode electrode side of the fuel cell main body 10 by opening the shut-off valve 62 (operation S706). Thereafter, the air that entered into the gas flow channel 6a of the anode electrode side during the shutdown of the fuel cell generating system 21 is expelled (displaced) to the outside.

After an amount of steam that is less than the volume of the gas flow channel 6a of the anode electrode side and that can separate the air that entered from the outside from a fuel gas) is supplied to the gas flow channel 6a of the anode electrode side, control valves 28 and 38 are opened to supply a raw gas and the steam to the reformer 30.

As a result, the steam reforming reaction indicated in equation (3), the shift reaction as indicated in equation (4), and the selective oxidation reaction are respectively generated in a reformer 30, a shift reactor 33, and a CO selective oxidation unit 34. Therefore, a hydrogen rich fuel gas is supplied to the anode electrode 3 of the fuel cell main body 10.

In the gas supplying system of FIG. 4, when used with the method of aspect of FIG. 7, as is the case where the pipeline configuration of FIG. 1 is used, the generation of adjacent regions of hydrogen and oxygen on the anode electrode 3 of the fuel cell main body 10 can be reduced or prevented (refer to FIG. 3A).

### Embodiment 3

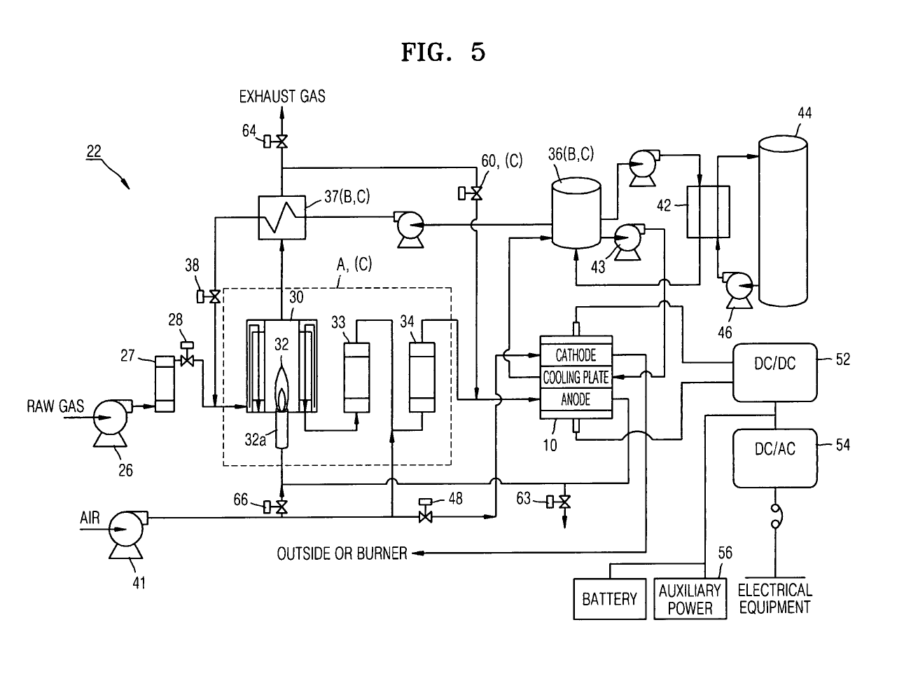

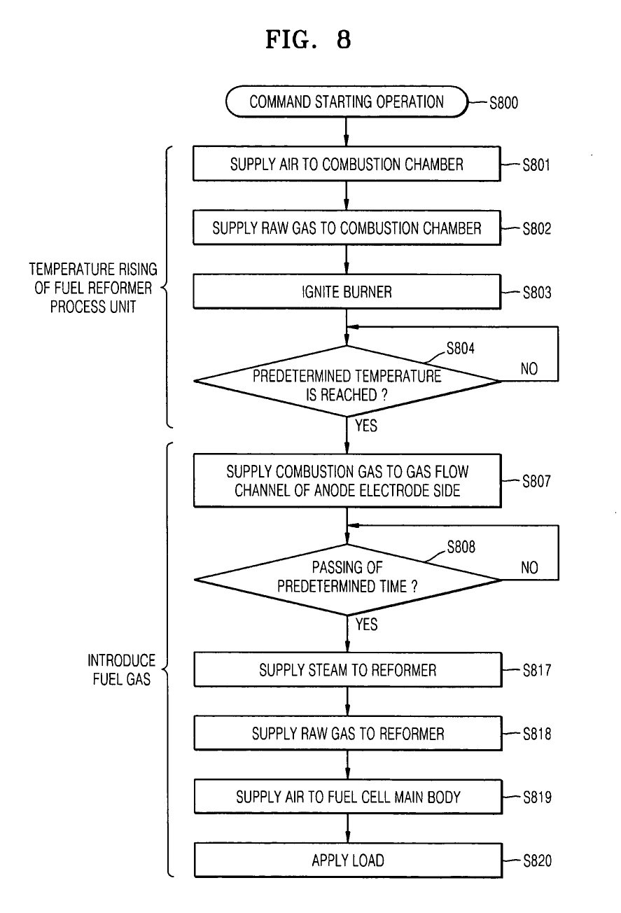

FIG. 5 illustrates a schematic drawing of a fuel cell generating system 22 according to an aspect of the present invention. FIG. 8 illustrates a flow chart of a starting operation method of the fuel cell generating system of an aspect of the present invention.

The functionality of the fuel cell generating system 22 and the configuration of a fuel cell main body 10 of the fuel cell generating system 22 of this aspect are identical to those of the aspect of FIG. 1. Accordingly, the detailed description thereof will be omitted. However, the starting operation is different as follows.

<Method of the Starting Operation>

In the fuel cell generating system 22 of FIG. 5, the starting operation method of the fuel cell generating system 22 will be described with reference to FIGS. 2, 5, and 8.

Referring to FIG. 5, the fuel cell generating system 22 includes an exhaust gas pipeline that exhausts a combustion gas from a combustion chamber 32 of a reformer 30. The exhaust gas pipeline is divided after passing through a vaporizer 37. Accordingly, the combustion gas from a combustion chamber 32 of the reformer 30 is supplied to a gas flow channel 6a of the anode electrode side of a fuel cell main body 10 through a shut-off valve 60 after exchanging heat with water in the vaporizer 37. Shut-off valves 63 and 64 are respectively connected to an outlet of the gas flow channel 6a of the anode electrode side of the fuel cell main body 10 and the exhaust gas pipeline of the vaporizer 37.

In this aspect of the method according to FIG. 8, the starting operation of the fuel cell generating system 22 and the temperature rising process of the reformer 30, a shift reactor 33, and a CO selective oxidation unit 34 are identical to that of the aspect of FIG. 6 (operations S600-S604).

Accordingly, after the temperatures of each of the reformer 30, the shift reactor 33, and the CO selective oxidation unit 34 have reached predetermined temperatures (operations S800-S804), a fuel introduction operation is performed. Then, the combustion gas from the combustion chamber 32 is supplied to the gas flow channel 6a of the anode electrode side of the fuel cell main body 10 by closing the shut-off valve 64 and simultaneously opening the shut-off valves 60 and 63 (operation S807). Thus, air that entered into the gas flow channel 6a of the anode electrode side during the shutdown of the fuel cell main body 10 is expelled out.

After an amount of combustion gas (that is less than the volume of the gas flow channel 6a of the anode electrode side and that can separate the air that entered from the outside from a fuel gas) is supplied to the gas flow channel 6a of the anode electrode side, the combustion gas is directed to the shut-off valve 64 by simultaneously opening the shut-off valve 64 and closing the shut-off valves 60 and 63. Afterwards, the control valves 28 and 38 are opened to supply a raw gas to the reformer 30.

As a non-reactive gas, the amount of combustion gas supplied to the gas flow channel 6a of the anode electrode side may be 80 to 100% of the total volume of the gas flow channel 6a of the anode electrode side.

If the amount of combustion gas supplied to the gas flow channel 6a of the anode electrode side is less than 80% of the total volume of the gas flow channel 6a of the anode electrode side, voltage of a local portion of the cathode electrode 2 at an outlet side of the gas flow channel 6a of the anode electrode side can be increased to 1.2 V even though the process takes (or is extant) for a short time.

On the other hand, if the amount of combustion gas supplied to the gas flow channel 6a of the anode electrode side exceeds 100% of the total volume of the gas flow channel 6a of the anode electrode side, the amount of combustion gas is greater than an amount of combustion gas usable to separate the air that entered from the outside from the fuel gas. Accordingly, the process is uneconomical by wasting combustion gas.

By the starting operation method according to the aspect of FIG. 8, the steam reforming reaction indicated in equation (3), the shift reaction as indicated in equation (4), and the selective oxidation reaction respectively occur in the reformer 30, the shift reactor 33, and the CO selective oxidation unit 34. Therefore, a hydrogen rich fuel gas is supplied to the anode electrode 3 of the fuel cell main body 10. Afterwards, when air is supplied to the cathode electrode 2 of the fuel cell main body 10 by opening the control valve 48, the fuel cell main body 10 is ready to generate electricity. Accordingly, power can be supplied to electrical equipment.

As described above, during the starting operation of the fuel cell generating system 22 according to aspects of the present invention, the combustion gas that does not participate in an electrochemical reaction can be interposed between air that entered into the gas flow channel 6a and a hydrogen rich fuel gas by temporarily supplying the combustion gas from the combustion chamber 32 before the hydrogen rich fuel gas is supplied to the gas flow channel 6a of the anode electrode side. In this way, the occurrence of the two separated regions (formation of an interface or adjacent regions) of hydrogen and oxygen on the anode electrode 3 of the fuel cell main body 10 can be reduced or prevented (refer to FIG. 3A).

### Embodiment 4

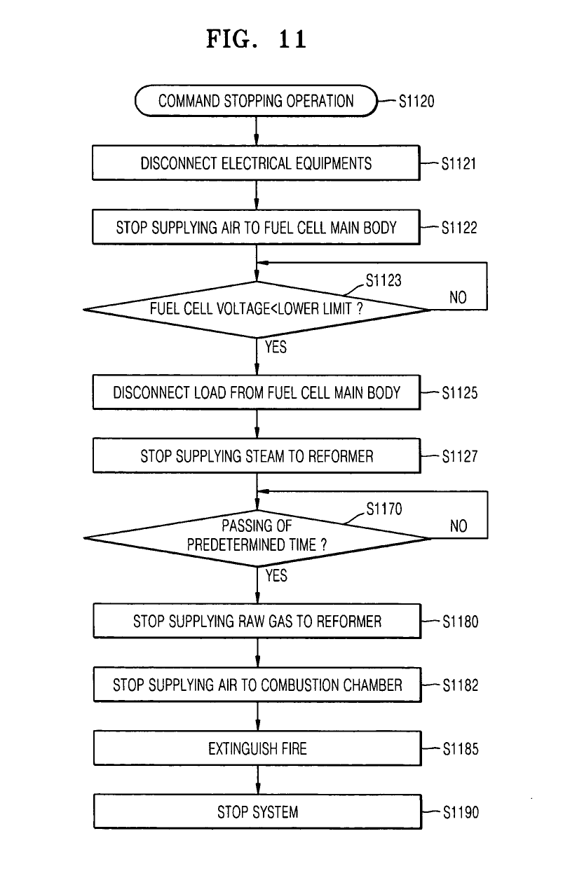

FIG. 11 illustrates a flow chart of a stopping operation method of the fuel cell generating system 20 of FIG. 1, according to an aspect of the present invention.

The configuration of the fuel cell generating system and the fuel cell main body of this aspect is basically identical to that of the aspect of FIG. 1, except for a stopping operation method. Accordingly, the detailed description thereof will be omitted.

<Method of the Stopping Operation>

The stopping operation method according to an aspect of FIG. 11 will be described with reference to FIGS. 1, 2, and 11. When the stopping operation of the fuel cell generating system 20 is performed, a breaker 65 is opened, and electrical equipment and the fuel cell generating system 20 are disconnected (operation S1121). Then, the air supply to the oxidant gas flow channels 5a of the cathode electrode side of the fuel cell main body 10 is stopped by closing the shut-off valve 48 (operation S1122). At this point, the fuel cell main body 10 can still generate electricity since air remains in the oxidant gas flow channels 5a of the cathode electrode side of the fuel cell main body 10, but the load of the fuel cell main body 10 is controlled by a controller (not shown) so that the voltage of the fuel cell main body 10 cannot exceed an upper voltage limit. Power generated at this point can be consumed at an auxiliary power 56 or can be used to charge a battery 57.

When the air remaining in the oxidant gas flow channels 5a of the cathode electrode side of the fuel cell main body 10 is consumed, an output voltage of the fuel cell main body 10 is reduced. When the output voltage of the fuel cell main body 10 reaches a lower limit (operation S1123), the controller disconnects the load from the fuel cell main body 10 (operation S1125), and closes the shut-off valve 38 to stop supplying steam to the reformer 30 (operation S1127). Meanwhile, a raw gas is still supplied to the reformer 30. However, the raw gas is supplied to the gas flow channel 6a of the anode electrode side of the fuel cell main body 10 through both the reformer 30 and the CO selective oxidation unit 34 without being reformed, and the raw gas expels the hydrogen rich fuel gas that remains in the gas flow channel 6a of the anode electrode side of the fuel cell main body 10 to the outside.

When an amount of the raw gas (that is greater than the volume of the gas flow channel 6a of the anode electrode side of the fuel cell main body 10) is supplied to the gas flow channel 6a of the anode electrode side of the fuel cell main body 10 (or when a predetermined time passes) (operation S1170), the control valve 28 is closed and the supply of the raw gas to the gas flow channel 6a of the anode electrode side of the fuel cell main body 10 is stopped (operation S1180).

Afterwards, the supply of combustion air to the combustion chamber 32 of the reformer 30 is stopped by closing a shut-off valve 66 (operation S1182), the combustion of a burner 32a in the combustion chamber 32 is stopped (operation S1185), and finally, the stoppage operation of the fuel cell generating system 20 is performed (operation S1190).

As illustrated in FIG. 3B, after a period of time from the stoppage operation of the fuel cell generating system 20, air enters from the outside into the gas flow channel 6a of the anode electrode side of the fuel cell main body 10. The air contacts the raw gas in the gas flow channel 6a of the anode electrode side of the fuel cell main body 10. That is, the inside of the gas flow channel 6a of the anode electrode side contains the non-reactive raw gas that does not contain oxygen, and which is present between the fuel gas and the air that entered from the outside. Thus, two separated regions (or adjacent regions) of hydrogen contained in the fuel gas and oxygen do not occur. Therefore, the significant increase in the cathode voltage can be reduced or prevented, the corrosion of the catalyst layer 2a of the cathode electrode 2 can be reduced prevented, and the durability of the fuel cell main body 10 can be significantly increased.

In the stopping operation of the fuel cell generating system 20 according to an aspect of the present invention, the hydrogen rich fuel gas remaining in the gas flow channel 6a of the anode electrode side of the fuel cell main body 10 can be expelled to the outside using the raw gas that does not participate in an electrochemical reaction by delaying the stoppage of the supply of the raw gas to the reformer 30 to a predetermined time later than the stoppage of the supply of the steam to the reformer 30. In this way, the occurrence of the two separated (or adjacent) regions of air that entered from the outside into the gas flow channel 6a of the anode electrode side of the fuel cell main body 10 during the shutdown and hydrogen contained in the hydrogen rich fuel gas remaining in the gas flow channel 6a of the anode electrode side of the fuel cell main body 10 can be reduced or prevented (refer to FIG. 3B).

In the stopping operation according this aspect, the hydrogen rich fuel gas remaining in the gas flow channel 6a of the anode electrode side of the fuel cell main body 10 is expelled to the outside by the supply of the raw gas and the raw gas remains in the gas flow channel 6a using the pipeline configuration of FIG. 1 as a gas supplying system. However, the same result can be obtained with a gas supply system C as depicted in FIG. 4 is used, in which a shut-off valve 63 is disposed on an upstream of an inlet of the gas flow channel 6a of the anode electrode side, and also, with a pipeline that is connected from an outlet of the desulfurizer 27 to an inlet of the gas flow channel 6a of the anode electrode side of the fuel cell main body 10 through a shut-off valve 61.

When using the fuel cell generating system of FIG. 4, the stopping operation includes an operation to reduce an output voltage of the fuel cell main body 10 due to the stoppage of supplying air to the oxidant gas flow channels 5a of the cathode electrode side (operation S1122). When the output voltage of the fuel cell main body 10 reaches a lower limit (operation S1123), a load of the fuel cell main body 10 is disconnected and the control valves 28 and 38 are closed to respectively stop supplying the steam (operation S1127) to the reformer 30 by a controller (not shown). Also, at the same time, the shut-off valve 63 is closed and the shut-off valve 61 is opened to supply (or to continue the supply of) the raw gas to the gas flow channel 6a of the anode electrode side of the fuel cell main body 10. Therefore, the hydrogen rich fuel gas remaining in the gas flow channel 6a of the anode electrode side of the fuel cell main body 10 is expelled to the outside by the raw gas.

After an amount of raw gas (greater than the volume of the gas flow channel 6a of the anode electrode side of the fuel cell main body 10) is supplied to the gas flow channel 6a of the anode electrode side (or after a predetermined time passes) (operation S1170), the shut-off valve 61 is closed to stop supplying the raw gas to the gas flow channel 6a of the anode electrode side of the fuel cell main body 10 (operation S1180). Afterwards, the supply of the combustion air to the combustion chamber 32 is stopped by closing the shut-off valve 66 (operation S1182), the operation of a burner 32a in the combustion chamber 32 is stopped (operation S1185), and finally, the stopping operation of the fuel cell generating system is preformed (operation S1190).

In this configuration of gas supplying system, as in the case that the pipeline configuration of FIG. 1, the occurrence of the adjacent regions of hydrogen and oxygen on the anode electrode 3 can be reduced or prevented.

### Embodiment 5

A fuel cell generating system according to an aspect of the present invention will be described. In this aspect, the configuration of the fuel cell generating system and the fuel cell main body 10 is basically identical to the aspect of FIG. 1 except for the stopping operation method. Accordingly, the detailed description thereof will not be repeated.

<Method of Stopping Operation>

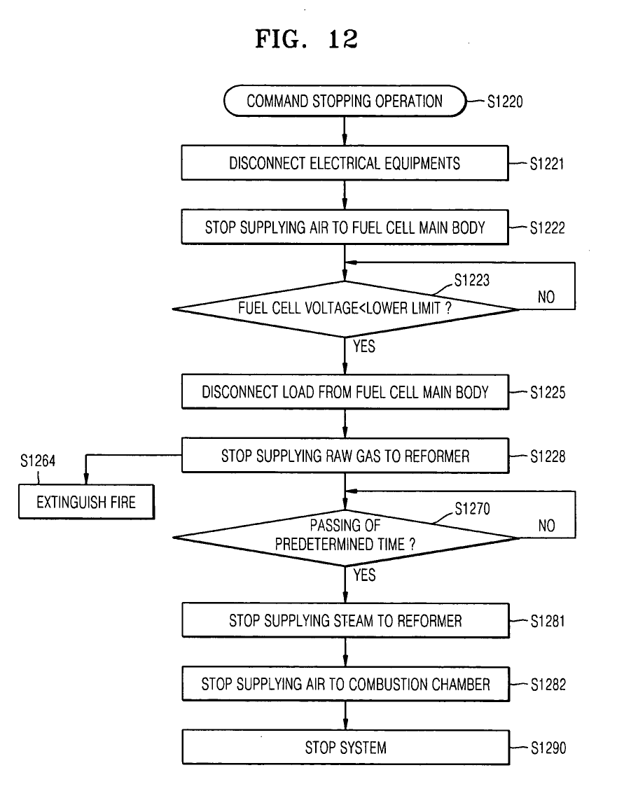

In the fuel cell generating system 20 of FIG. 1, a stopping operation method will be described with reference to FIGS. 1, 2, and 12. FIG. 12 illustrates a flow chart of a stopping operation method of the fuel cell generating system according to an aspect of the present invention.

After a stopping operation of the fuel cell generating system 20 is conducted, supplying air to the oxidant gas flow channels 5a of the cathode electrode side is stopped, an output voltage of the fuel cell main body 10 is reduced, and a load from the fuel cell main body 10 is disconnected by a controller (not shown) when the output voltage of the fuel cell main body 10 reaches the lower limit (operations S1220-S1225). These processes are the same as that of aspect of FIG. 11 (operations S1120-S1125).

As shown in FIG. 12, the supply of raw gas to the reformer 30 is stopped by the closing of the shut-off valve 28 (operation S1228). Meanwhile, steam is still supplied to the reformer 30. Therefore, the steam is supplied to the gas flow channel 6a of the anode electrode side of the fuel cell main body 10 through the reformer 30 and the CO selective oxidation unit 34 without undergoing a reforming reaction. Accordingly, the steam expels the hydrogen rich fuel gas remaining in the gas flow channel 6a of the anode electrode side of the fuel cell main body 10 to the outside. At this time, when the supply of the hydrogen rich fuel gas to the combustion chamber 32 from an outlet of the gas flow channel 6a of the anode electrode side of the fuel cell main body 10 is stopped (operation S1228), the fire of the burner 32a in the combustion chamber 32 is extinguished (operation S1264). Then, after an amount of steam that is greater than the volume of the gas flow channel 6a of the anode electrode side of the fuel cell main body 10 is supplied to the gas flow channel 6a of the anode electrode side (or after a predetermined time passes) (operation S1270), the control valve 38 is closed and the supply of steam to the gas flow channel 6a of the anode electrode side of the fuel cell main body 10 is stopped (operation S1281). Afterwards, the supply of combustion air to the combustion chamber 32 is stopped by closing the shut-off valve 66 (operation S1282). Thus, the combustion of the burner 32a in the combustion chamber 32 is stopped, and the stoppage operation of the fuel cell generating system 20 is performed (operation S1290).

When the control valves 28 and 38 are closed, the supply of the hydrogen rich fuel gas to the gas flow channel 6a of the anode electrode side of the fuel cell main body 10 is stopped. Therefore, the supply of fuel gas to the burner 32a in the combustion chamber 32 is also stopped, and thus, the combustion chamber 32 is in a combustion stop state. If the generation of steam for an amount equal to the volume of the gas flow channel 6a of the anode electrode side of the fuel cell main body 10 is difficult due to the stoppage of the combustion chamber 32, the combustion of raw gas can be continued in the combustion chamber 32 by supplying the raw gas to the combustion chamber 32 through a pipeline (not shown) in the same manner as the temperature rising operation of the reformer 30 during the starting operation of the fuel cell generating system.

In the stopping operation of the fuel cell generating system 20 according to an aspect of the present invention, the hydrogen rich fuel gas remaining in the gas flow channel 6a of the anode electrode side of the fuel cell main body 10 can be expelled to the outside using steam that does not participate in an electrochemical reaction by delaying the stoppage of the supply of the steam to the reformer 30 to a predetermined time later than the stoppage of the supply of the raw gas to the reformer 30. In this way, the occurrence of the two separated regions (or adjacent regions) of air that entered from the outside into the gas flow channel 6a of the anode electrode side of the fuel cell main body 10 during shutdown and hydrogen contained in the hydrogen rich fuel gas remaining in the gas flow channel 6a of the anode electrode side of the fuel cell main body 10 can be reduced or prevented (refer to FIG. 3B).

In the fuel cell generating system 20 according this aspect, since only steam is supplied to the anode electrode 3 for a predetermined time, this system is suitable for a fuel cell generating system in which the fuel cell main body 10 is operated at a temperature over 100° C.

In this aspect of the stopping operation using the fuel cell generating system 20, steam is used to expel the hydrogen rich fuel gas in the gas flow channel 6a of the anode electrode side of the fuel cell main body 10 to the outside using the pipeline configuration of FIG. 1 as a gas supplying system. However, the same results can be obtained if a gas supply system C is used as depicted in FIG. 4, in which a shut-off valve 62 is installed upstream of a gas flow channel 6a of an anode electrode side, and a pipeline is connected from an outlet of a vaporizer 37 to an inlet of the gas flow channel 6a of an anode electrode side of a fuel cell main body 10 through the shut-off valve 62.

According to a stopping operation of this aspect, an output voltage of the fuel cell main body 10 is reduced due to the stoppage of air supplied to the oxidant gas flow channels 5a of the cathode electrode side. When the output voltage of the fuel cell main body 10 reaches a lower limit, a load of the fuel cell main body 10 is disconnected and the control valves 28 and 38 are closed to stop the supply of the raw gas and the steam to the reformer 30 by a controller (not shown). Also, at the same time, the shut-off valve 62 is opened to supply the steam to the gas flow channel 6a of the anode electrode side. Therefore, the hydrogen rich fuel gas remaining in the gas flow channel 6a of the anode electrode side is expelled to the outside by the steam. When an amount of steam greater than the volume of the gas flow channel 6a of the anode electrode side is supplied to the gas flow channel 6a of the anode electrode side, the shut-off valve 62 is closed to stop the supply of the steam to the gas flow channel 6a of the anode electrode side.

Afterwards, the supply of combustion air to the combustion chamber 32 is stopped by closing the shut-off valve 66, the operation of a burner 32a in the combustion chamber 32 is stopped, and finally, the stopping operation of the fuel cell generating system 21 is preformed. In this aspect of the gas supplying system, as with the case of the pipeline configuration of FIG. 1, the occurrence of adjacent regions of hydrogen and oxygen on the anode electrode 3 of the fuel cell main body 10 can be reduced or prevented (refer to FIG. 3B).

### Embodiment 6

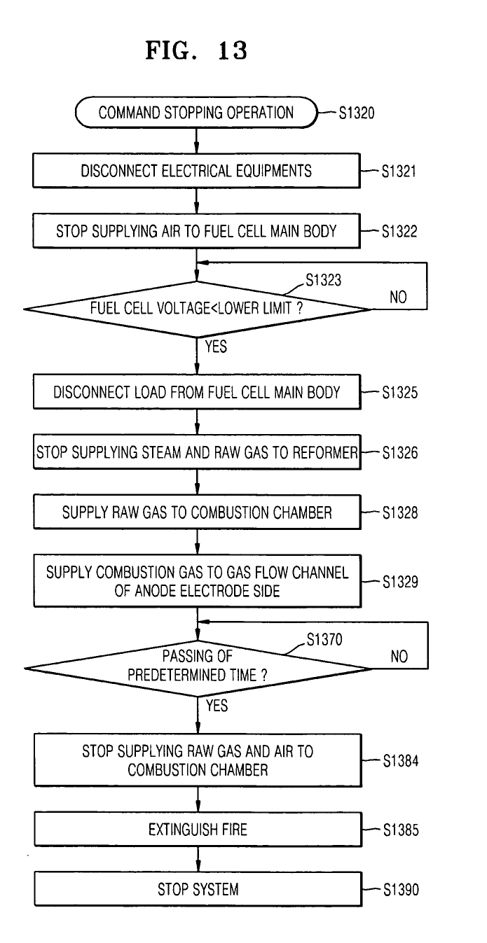

FIG. 13 illustrates a flow chart of a stopping operation method of the fuel cell generating system, according an aspect of the present invention.

The basic configuration of the fuel cell generating system 22 of FIG. 5 and the fuel cell main body 10 is identical to that of the aspect of FIG. 1 except for the stopping operation.

<Method of the Stopping Operation>

The fuel cell generating system 22 according to FIG. 5 and the stopping operation method according to FIG. 13 will be described with reference to FIGS. 2, 5, and 13.

In this aspect, the stopping operation of the fuel cell generating system 22, the stoppage of supply of air to the oxidant gas flow channels 5a of the cathode electrode side, the reduction of the output voltage of the fuel cell main body 10, and the disconnection of the load from the fuel cell main body 10 by a controller (not shown) when the output voltage of the fuel cell main body 10 reaches the lower limit (operations S1320-S1325) are the same as the processes of the method of the aspect of FIG. 11 (operations S1120-S1125).

As shown in FIG. 13, the supply of raw gas and steam to the reformer 30 is stopped by closing shut-off valves 28 and 38 (operation S1325). Also, at the same time, the combustion in the combustion chamber 32 can be continued by supplying the raw gas to the combustion chamber 32 through a pipeline in the same manner as the temperature rising operation of the reformer 30 used to start the fuel cell generating system (operation S1328).

Then, the hydrogen rich fuel gas remaining in the gas flow channel 6a of the anode electrode side is expelled to the outside by supplying a combustion gas from the combustion chamber 32 of the reformer 30 to the gas flow channel 6a of the anode electrode side by closing the shut-off valve 64 and opening the shut-off valves 60 and 63 (operation S1329). After an amount of combustion gas greater than the volume of the gas flow channel 6a of the anode electrode side is supplied to the gas flow channel 6a of the anode electrode side (or after a predetermined time passes) (operation S1370), the combustion gas is directed towards the shut-off valve 64 by opening the shut-off valve 64 and closing the shut-off valve 63.

Then, the combustion of fuel in the burner 32a in the combustion chamber 32 of the reformer 30 is stopped (operation S1385) by closing the shut-off valve 66 and a raw gas supply valve (not shown) that supplies the raw gas to the combustion chamber 32 of the reformer 30 and by cutting the supply of combustion air and the raw gas to the combustion chamber 32 of the reformer 30 (operation S1384). Accordingly, the stoppage operation of the fuel cell generating system is performed (operation S1390).

In the stopping operation of the fuel cell generating system according to an aspect present invention, the hydrogen rich fuel gas remaining in the gas flow channel 6a of the anode electrode side can be expelled to the outside by temporarily introducing the combustion gas that does not participate in an electrochemical reaction from the combustion chamber 32 of the reformer 30 to the gas flow channel 6a of the anode electrode side after the supply of the hydrogen rich fuel gas to the gas flow channel 6a of the anode electrode side is stopped. In this way, the occurrence of adjacent regions of air that entered from the outside into the gas flow channel 6a of the anode electrode side during shutdown and hydrogen contained in the hydrogen rich fuel gas remaining in the gas flow channel 6a of the anode electrode side of the fuel cell main body 10 can be reduced or prevented (refer to FIG. 3B).

### Embodiment 7

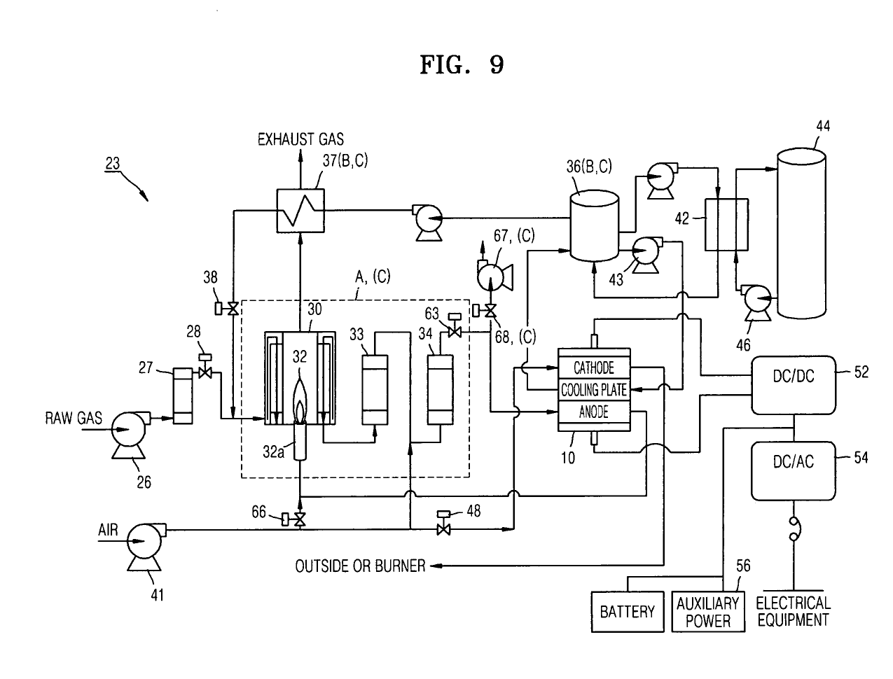

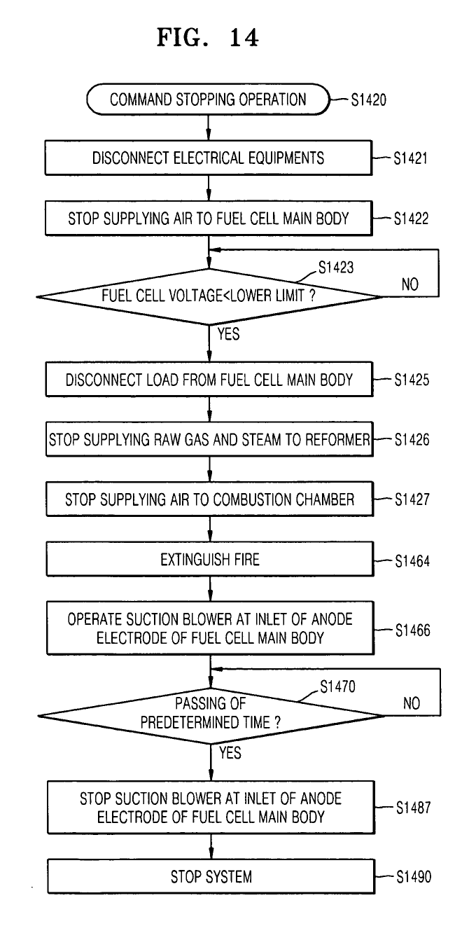

FIG. 14 illustrates a flow chart of a stopping operation method of a fuel cell generating system according to an aspect of the present invention. FIG. 9 illustrates a schematic drawing of the fuel cell generating system 23 in which the stopping operation of FIG. 14 is performed.

The basic configuration of the fuel cell generating system 23 and the fuel cell main body 10 is identical to that of the fuel cell generating system according to the aspect of FIG. 1. Accordingly, a detailed description thereof will be omitted.

<Method of Stopping Operation>

Using the fuel cell generating system 23 having the above configuration, the stopping operation method will be described with reference to FIGS. 2, 9, and 14. Referring to FIG. 9, the fuel cell generating system 23 includes a blower 67 that is connected to an inlet of a gas flow channel 6a of an anode electrode side of the fuel cell main body 10 through a shut-off valve 68.

The stopping operation of the fuel cell generating system 23, the processes of the stoppage operation of supplying air to oxidant gas flow channels 5a of a cathode electrode side of the fuel cell main body 10, the reduction of output voltage of the fuel cell main body 10, and the disconnection of the load from the fuel cell main body 10 by a controller (not shown) when the output voltage of the fuel cell main body 10 reaches the lower limit (operations S1420-S1425) are the same as the processes of the method of FIG. 11 (operations S1120-S1125).

Then, as shown in FIG. 14, the supply of raw gas and steam to a reformer 30 is stopped by the closing of shut-off valves 28 and 38 (operation S1426). Also, the combustion in a combustion chamber 32 of the reformer 30 is stopped (operation S1464) by cutting the supply of combustion air to the combustion chamber 32 of the reformer 30 (operation S1427). Then, a shut-off valve 63 that is connected to the inlet of the gas flow channel 6a of the anode electrode side of the fuel cell main body 10 is closed, the shut-off valve 68 is opened, and the blower 67 is operated (operation S1466). As a result, the flow of gas in the gas flow channel 6a of the anode electrode side of the fuel cell main body 10 becomes opposite to the flow of gas in a normal operation. Accordingly, the hydrogen rich fuel gas remaining in the gas flow channel 6a of the anode electrode side of the fuel cell main body 10 is exhausted through the blower 67, and the combustion gas in the downstream flow of the combustion chamber 32 of the reformer 30, the combustion gas around the vaporizer 37, is suctioned into the burner 32a and eventually directed to the gas flow channel 6a of the anode electrode side of the fuel cell main body 10.

After an amount of the combustion gas greater than the volume of the gas flow channel 6a of the anode electrode side of the fuel cell main body 10 is supplied to the gas flow channel 6a of the anode electrode side of the fuel cell main body 10 (or after a predetermined time passes) (operation S1470), the blower 67 is stopped and the shut-off valve 68 is closed. Accordingly, the stoppage operation of the fuel cell generating system 23 is performed (operation S1490).

As described above, during the stopping operation of the fuel cell generating system 23 according to this aspect, after cutting the supply of hydrogen rich fuel gas to the gas flow channel 6a of the anode electrode side of the fuel cell main body 10, the hydrogen rich fuel gas remaining in the gas flow channel 6a of the anode electrode side of the fuel cell main body 10 can be exhausted by forming a reverse flow of the hydrogen rich fuel gas in the gas flow channel 6a of the anode electrode side of the fuel cell main body 10. Consecutively, the combustion gas at the combustion chamber 32 that does not participate in an electrochemical reaction can be directed into the gas flow channel 6a of the anode electrode side of the fuel cell main body 10. In this way, the occurrence of the adjacent regions of air that entered from the outside into the gas flow channel 6a of the anode electrode side of the fuel cell main body 10 during shutdown and hydrogen (fuel gas) contained in the hydrogen rich fuel gas remaining in the gas flow channel 6a of the anode electrode side of the fuel cell main body 10 can be reduced or prevented (refer to FIG. 3B).

### Embodiment 8

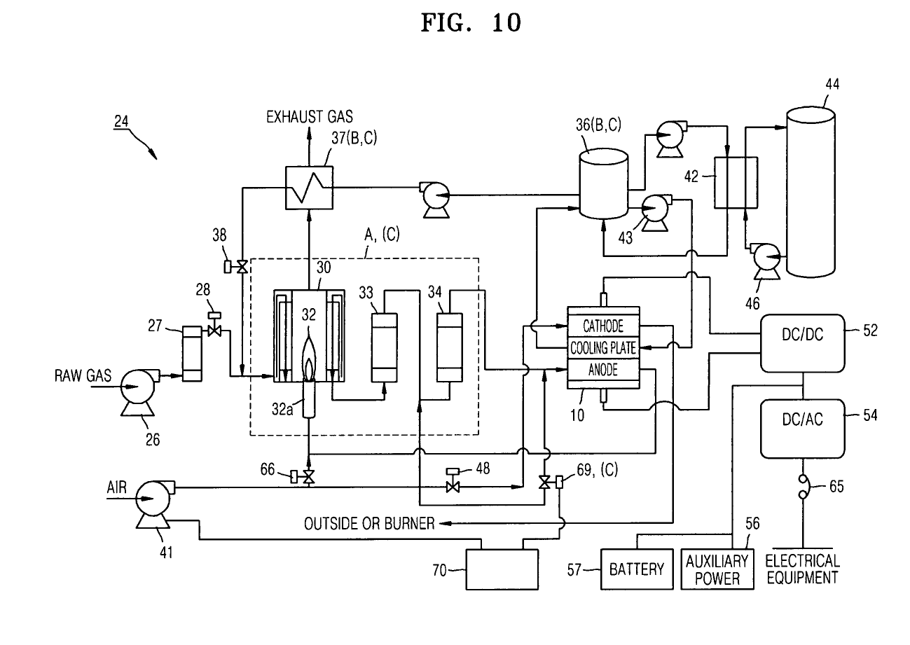

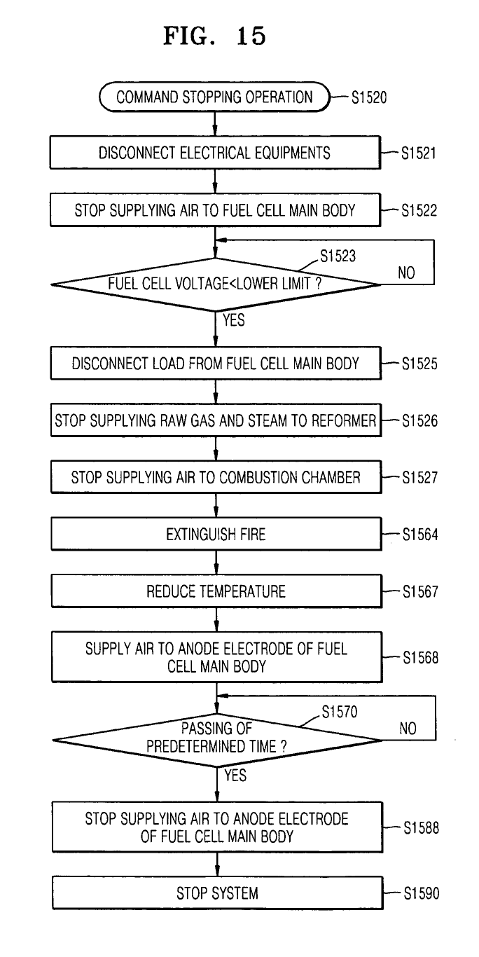

FIG. 15 illustrates a flow chart of a stopping operation method of the fuel cell generating system according an aspect of the present invention. FIG. 10 illustrates a schematic drawing of a fuel cell generating system 24 which is adopted for the aspect of FIG. 15.

The functionality of the fuel cell generating system 24 and the configuration of a fuel cell main body 10 of the fuel cell generating system 24 are basically identical to that of the aspect of FIG. 1. Accordingly, a detailed description thereof will be omitted.

<Method of the Stopping Operation>

In the fuel cell generating system 24 having the above configuration, the method of stopping operation will be described with reference to FIGS. 2, 10, and 15. The fuel cell generating system 24 has a pipeline configuration to direct air (an oxidant gas) supplied from an air blower 41 to a gas flow channel 6a of an anode electrode side of the fuel cell main body 10 through a shut-off valve 69. Also, the fuel cell generating system 24 includes a gas flow computing controller 70 that calculates a time taken for air to enter the gas flow channel 6a of the anode electrode side of the fuel cell main body 10 after cutting of the supply of the fuel gas to the fuel cell main body 10. The taken time is calculated based on the figures of the volume of the gas flow channel 6a of the anode electrode side of the fuel cell main body 10, the diffusion speed of hydrogen and oxygen, and the rate of volume reduction of the fuel gas in the gas flow channel 6a of the anode electrode side of the fuel cell main body 10 due to a temperature reduction of the fuel cell main body 10. Accordingly, the air blower 41 and the shut-off valve 69 are controlled.

After the stopping operation of the fuel cell generating system 23 is initiated, the processes of stopping the supply of air to the oxidant gas flow channels 5a of the cathode electrode side, the reduction of output voltage of the fuel cell main body 10, and the disconnection of the load from the fuel cell main body 10 by a controller (not shown) when the output voltage of the fuel cell main body 10 reaches the lower limit (operations S1520-S1525) are the same as the aspect of FIG. 11 (operations S1120-S1125).

As shown in FIG. 14, the supply of raw gas and steam to a reformer 30 is stopped by closing shut-off valves 28 and 38 (operation S1526). Also, at the same time the supply of combustion air to a combustion chamber 32 of the reformer 30 is cut (operation S1527. Accordingly, the combustion of a burner 32a in the combustion chamber 32 of the reformer 30 is stopped (operation S1564). After that, the temperature of the fuel cell generating system 24 is reduced (operation S1567) and the pressure in the gas flow channel 6a of the anode electrode side of the fuel cell main body 10 is reduced because the hydrogen remaining in the gas flow channel 6a of the anode electrode side of the fuel cell main body 10 is consumed by reacting with oxygen remaining in the cathode electrode 2 through the electrolyte membrane 4. Accordingly, there is volume reduction corresponding to the temperature reduction.

Since external air is suctioned into the gas flow channel 6a of the anode electrode side of the fuel cell main body 10 due to the pressure reduction in the gas flow channel 6a of the anode electrode side of the fuel cell main body 10, the gas flow computing controller 70 included in the fuel cell generating system 24 calculates in advance a time for the external air to enter the gas flow channel 6a of the anode electrode side of the fuel cell main body 10 based on values of the volume of the pipeline and properties of the gases, and controls the air blower 41 (an oxidant gas supply system) and the shut-off valve 69 to operate within a calculated time. In this way, air is supplied to the gas flow channel 6a of the anode electrode side of the fuel cell main body 10 from an inlet of the gas flow channel 6a of the anode electrode side of the fuel cell main body 10.

After an amount of air greater than the volume of the gas flow channel 6a of the anode electrode side of the fuel cell main body 10 is supplied to the gas flow channel 6a of the anode electrode side of the anode electrode side of the fuel cell main body 10 by the air blower 41 (and/or after a predetermined time passes) (operation S1570), the air blower 41 is stopped (operation S1588). Due to the closing of the shut-off valve 69, the stoppage operation of the fuel cell generating system 24 is performed (operation S1590).

As described above, during the stopping operation of the fuel cell generating system 24 according this aspect, the fuel cell generating system 24 forcefully expels the hydrogen remaining in the gas flow channel 6a of the anode electrode side of the fuel cell main body 10 to the outside using air by operation of the gas flow computing controller 70. Therefore, the time of the occurrence of the two separated regions of remaining hydrogen and air that entered from the outside on the anode electrode 3 of the fuel cell main body 10 can be reduced to a very short time, to thereby prevent the degradation of the fuel cell main body 10 (refer to FIG. 3B). Also, the temperature of the fuel cell main body 10 is further reduced by supplying atmospheric air to the gas flow channel 6a of the anode electrode side of the fuel cell main body 10 until external air enters into the gas flow channel 6a of the anode electrode side of the fuel cell main body 10. In this way, the corrosion phenomenon due to the occurrence of the two separated regions of hydrogen and oxygen on the anode electrode 3 of the fuel cell main body 10 during forced supplying of air into the gas flow channel 6a of the anode electrode side of the fuel cell main body 10 can be hindered in view of temperature effects.

According to various aspects of the present invention, by using the various fuel cell generating system described above, the occurrence of the adjacent regions of hydrogen and oxygen on an anode electrode of a fuel cell main body during the starting and stopping operations can be reduced or prevented. Therefore, the degradation of a fuel cell main body can be reduced or prevented and the durability of the fuel cell main body can be increased without increasing the volume of the fuel cell generating system.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A fuel cell generating system comprising a fuel cell main body that comprises an electrolyte membrane, an anode electrode and a cathode electrode disposed on separate sides of the electrolyte membrane, a first separator having gas flow channels that supply a fuel gas containing hydrogen to the anode electrode and a second separator having oxidant gas flow channels that supply an oxidant gas containing oxygen to the cathode electrode, wherein the fuel cell generating system further comprises:
a gas supply system to supply a non-reactive gas besides the oxidant gas and the fuel gas to the gas flow channel of the anode electrode side,
wherein, during a starting operation of the fuel cell generating system, a predetermined amount of the non-reactive gas is supplied to the gas flow channel of the anode electrode side by the gas supply system, and the fuel gas is supplied after the supplying of the non-reactive gas.

2. The fuel cell generating system of claim 1, wherein the amount of the non-reactive gas supplied to the gas flow channel of the anode electrode side gas supply system is less than a volume of the gas flow channel of the anode electrode side, to separate the fuel gas that is supplied after the non-reactive gas is supplied from a remaining gas in the gas flow channel of the anode electrode side.

3. The fuel cell generating system of claim 1, further comprising:
a gas purifying unit that purifies a raw gas;
a fuel reforming process unit that generates the fuel gas supplied to the fuel cell main body using the raw gas purified in the gas purifying unit, and
a steam supply system that supplies steam to the fuel reforming process unit,
wherein the non-reactive gas supplied to the gas flow channel of the anode electrode side is the raw gas purified in the gas purifying unit.

4. The fuel cell generating system of claim 1, further comprising:
a gas purifying unit that purifies a raw gas;
a fuel reforming process unit that generates the fuel gas supplied to the fuel cell main body by reforming the raw gas that is purified in the gas purifying unit; and
a steam supply system that supplies steam to the fuel reforming process unit,
wherein the non-reactive gas supplied to the gas flow channel of the anode electrode side is the steam produced in the steam supply system.

5. The fuel cell generating system of claim 1, further comprising:
a gas purifying unit that purifies a raw gas;
a fuel reforming process unit that generates the fuel gas supplied to the fuel cell main body by reforming the raw gas that is purified in the gas purifying unit; and
a steam supply system that supplies steam to the fuel reforming process unit,
wherein the non-reactive gas supplied to the gas flow channel of the anode electrode side is a combustion gas exhausted from the fuel reforming process unit.

6. The fuel cell generating system of claim 5, further comprising a suction device connected to an inlet of the gas flow channel of the anode electrode side and a burner in a combustion unit that is included in the fuel reforming process unit,
wherein an outlet of the gas flow channel of the anode electrode side is connected to the burner in the combustion unit, and
the suction device performs a suction operation when the supply of the fuel gas to the fuel cell main body is cut due to a stoppage of the fuel cell main body to exhaust the fuel gas remaining in the gas flow channel of the anode electrode side to the outside and to direct the combustion gas remaining in the combustion unit of the fuel reforming process unit through the burner into the gas flow channel of the anode electrode side.

7. A fuel cell generating system comprising a fuel cell main body that comprises an electrolyte membrane, an anode electrode and a cathode electrode disposed on separate sides of the electrolyte membrane, a first separator having gas flow channels that supply a fuel gas containing hydrogen to the anode electrode and a second separator having oxidant gas flow channels to supply an oxidant gas containing oxygen to the cathode electrode, wherein the fuel cell generating system further comprises:
a gas supply system that supplies a non-reactive gas besides the oxidant gas and the fuel gas to the gas flow channels of the anode electrode side,
wherein, during a stopping operation of the fuel cell generating system, the non-reactive gas is supplied to the gas flow channel of the anode electrode side immediately after the supply of the fuel gas by the gas supply system.

8. The fuel cell generating system of claim 7, wherein the amount of non-reactive gas supplied to the gas flow channel of the anode electrode side is greater than a volume of the gas flow channel of the anode electrode side.

9. The fuel cell generating system of claim 7, further comprising:
a gas purifying unit that purifies a raw gas;
a fuel reforming process unit that generates the fuel gas supplied to the fuel cell main body by reforming the raw gas that is purified in the gas purifying unit; and
a steam supply system that supplies steam to the fuel reforming process unit,
wherein the non-reactive gas supplied to the gas flow channel of the anode electrode side is the raw gas purified in the gas purifying unit.

10. The fuel cell generating system of claim 7, further comprising:
a gas purifying unit that purifies a raw gas;
a fuel reforming process unit that generates the fuel gas supplied to the fuel cell main body by reforming the raw gas that is purified in the gas purifying unit; and
a steam supply system that supplies steam to the fuel reforming process unit,
wherein the non-reactive gas supplied to the gas flow channel of the anode electrode side is the steam produced in the steam supply system.

11. The fuel cell generating system of claim 7, further comprising:
a gas purifying unit that purifies a raw gas,
a fuel reforming process unit that generates the fuel gas supplied to the fuel cell main body using the raw gas purified in the gas purifying unit, and
a steam supply system that supplies steam to the fuel reforming process unit,
wherein the non-reactive gas supplied to the gas flow channel of the anode electrode side is a combustion gas exhausted from the fuel reforming process unit.

12. The fuel cell generating system of claim 7, further comprising a suction device connected to an inlet of the gas flow channel of the anode electrode side and a burner in a combustion unit that is included in the fuel reforming process unit,
wherein an outlet of the gas flow channel of the anode electrode side is connected to the burner in the combustion unit, and
the suction device performs a suction operation when the supply of the fuel gas to the fuel cell main body is cut due to a stoppage of the fuel cell main body to exhaust the fuel gas remaining in the gas flow channel of the anode electrode side to the outside and to direct the combustion gas remaining in the combustion unit of the fuel reforming process unit through the burner into the gas flow channel of the anode electrode side.

13. A fuel cell generating system comprising a fuel cell main body that comprises an electrolyte membrane, an anode electrode and a cathode electrode disposed on separate sides of the electrolyte membrane, a first separator having gas flow channels that supply a fuel gas containing hydrogen to the anode electrode and a second separator having oxidant gas flow channels that supply an oxidant gas containing oxygen to the cathode electrode, wherein the fuel cell generating system further comprises:
an oxidant gas supply system that supplies an oxidant gas to the cathode electrode,
wherein the oxidant gas supply system is connected to the gas flow channel of the anode electrode side, and, when the fuel cell generating system is stopped, the fuel gas remaining in the gas flow channel of the anode electrode side is removed by the supply of the oxidant gas into the gas flow channel of the anode electrode side from the oxidant gas supply system.

14. The fuel cell generating system of claim 13, further comprising a gas flow computing controller that calculates a time required for external air to enter the gas flow channel of the anode electrode side after the supply of fuel gas to the fuel cell main body is cut using figures of a volume of the gas flow channel of the anode electrode side, a speed of diffusion of hydrogen and oxygen, and a volume reduction of the fuel gas in the gas flow channel of the anode electrode side due to a temperature reduction of the fuel cell main body,
wherein the gas flow computing controller removes the fuel gas remaining in the gas flow channel of the anode electrode side until the calculated time has passed after the supply of the fuel gas to the fuel cell main body has been cut.

15. A starting operation method of an apparatus comprising a fuel cell and a fuel reformer, comprising:
raising a temperature of the fuel reformer;
supplying a first non-inert gas to the fuel cell;
supplying a second non-inert gas to the fuel cell; and
supplying a fuel gas to the fuel cell, wherein the first non-inert gas is interposed between the fuel gas and an oxidant.

16. The method of claim 15, wherein the first non-inert gas is at least one of raw fuel and combustion gas, and the second non-inert gas is steam.

17. The method of claim 15, wherein the first non-inert gas is at least one of steam and combustion gas, and the second non-inert gas is raw fuel.

18. A stopping operation method of an apparatus comprising a fuel cell and a fuel reformer, comprising:
stopping supply of air to the fuel reformer;
stopping supply of a first non-inert gas to the fuel cell but continuing supply of a second non-inert gas to the fuel cell; and
stopping supply of a fuel gas to the fuel cell, wherein the first non-inert gas is interposed between the fuel gas and an oxidant.

19. The method of claim 18, wherein the first non-inert gas is one of a raw fuel, steam or a combustion gas, and the second non-inert gas is one of the remaining two.
